(19) United States
(12) Patent Application Publication
(10) Pub. No.: US 2025/0370830 A1
(43) Pub. Date: Dec. 4, 2025

(54) INDEPENDENT MOBILE TELECOMMUNICATION ENHANCEMENT OPERATION INTEGRATION PLATFORM INCLUDING DATA STRUCTURE TRANSLATION

(71) Applicant: DISH Wireless L.L.C., Englewood, CO (US)

(72) Inventors: Eran Eldar, Littleton, CO (US); Robert Bennett, Castle Rock, CO (US); Suresh Kannan Ramaraju, Denver, CO (US); Mani Pajouh, Denver, CO (US)

(21) Appl. No.: 18/827,312

(22) Filed: Sep. 6, 2024

Related U.S. Application Data
(60) Provisional application No. 63/653,656, filed on May 30, 2024.

(51) Int. Cl. G06F 9/54

(52) U.S. Cl. CPC G06F 9/541

(57) ABSTRACT

A disclosed method may include identifying, by a mobile operator or an independent mobile telecommunication enhancement operation that provides a mobile telecommunication enhancement for clients of the mobile operator, an application programming interface that integrates the mobile operator with the independent mobile telecommunication enhancement operation such that the application programming interface translates between data structures for fields that record mobile service operation details in a format that the mobile operator uses internally and second data structures for corresponding fields.

### BRIEF SUMMARY

This disclosure is generally directed to systems, methods, and computer-readable media relating to an independent mobile telecommunication enhancement operation integration platform. In general, mobile operators, including both mobile network operators and mobile virtual network operators, have the capability to offer numerous value-added services to customers, including television, streaming, storage, and/or various telecommunication-related services. Each partner can have unique requirements for onboarding, integration, testing, and launching their services. This can present significant challenges for mobile operators worldwide.

The following describes various challenges related to integrating mobile operators with value-added service providers. Each partner can have unique integration requirements, particularly in a telecommunication environment, with respect to the application programming interface that is used, which can lead to complexity and challenges in meeting individual demands effectively. The processes of onboarding new providers and integrating their services can be time-consuming, potentially delaying the launch of new offerings and impacting time-to-market. Any changes to rules or compatibility for introducing new offerings or products can require several weeks to implement, leading to prolonged time-to-market and increased implementation costs. These extended implementation periods can not only delay revenue generation but can also escalate project expenses. Implementing customized rules per service provider adds complexity to operational procedures, which can make it more difficult to streamline processes and maintain efficiency. As subscription service grows, scaling operations to meet increasing demand can be challenging. Moreover, maintaining consistency in customer's information and ensuring uniform quality service across the partner offerings present challenges for operational and service reliability.

In related solutions, the configuration between mobile operators and value-added service providers presents several problems. Competitors typically require up to two months to launch a new service with a partner, causing potential delays in time-to-market. They exhibit limited flexibility in outbound communications with partners, restricting customization options. The integration methods offered are also limited, primarily relying on application programming interfaces and file transfers, with event-driven integration being absent, which restricts the ability to adapt to diverse integration needs and hinders real-time data exchange. Additionally, any changes in existing products or methods on the application programming interfaces necessitate development efforts, further complicating the process. Integrating with a partner for outbound communication usually requires development based on their payload, adding complexity and potentially increasing the time and resources needed for integration.

In view of the above, this disclosure describes various embodiments of technology that can help address one or more of these deficiencies. Additionally, or alternatively, this disclosure also reveals various embodiments of technology that provide further numerous benefits, as described in more detail below.

In some examples of a first embodiment, a method includes (i) identifying, by a mobile operator or an independent mobile telecommunication enhancement operation that provides a mobile telecommunication enhancement for clients of the mobile operator, an application programming interface that integrates the mobile operator with the independent mobile telecommunication enhancement operation such that the application programming interface enables the independent mobile telecommunication enhancement operation to proactively edit a field of an authoritative profile that is maintained by the mobile operator and that is specific to the independent mobile telecommunication enhancement operation or is specific to a client to which the independent mobile telecommunication enhancement operation is providing the mobile telecommunication enhancement and (ii) providing or accessing, by the mobile operator or the independent mobile telecommunication enhancement operation that provides the mobile telecommunication enhancement for clients of the mobile operator, the application programming interface that integrates the mobile operator with the independent mobile telecommunication enhancement operation such that the application programming interface enables the independent mobile telecommunication enhancement operation to proactively edit the field of the authoritative profile that is maintained by the mobile operator and that is specific to the independent mobile telecommunication enhancement operation or is specific to the client to which the independent mobile telecommunication enhancement operation is providing the mobile telecommunication enhancement.

In some examples of the first embodiment, the mobile telecommunication enhancement comprises a cable-television option, a secure Wi-Fi Internet connection option, an international calling option, a cloud storage option, a Voice Over Internet Protocol option, a streaming content service membership option, or a device insurance option.

In some examples of the first embodiment, the field of the authoritative profile comprises a specification of whether the mobile telecommunication enhancement has been applied as a bolton to the authoritative profile that is specific to the client to which the independent mobile telecommunication enhancement operation is providing the mobile telecommunication enhancement.

In some examples of the first embodiment, the method further includes the independent mobile telecommunication enhancement operation editing the field of the authoritative profile comprising the specification of whether the mobile telecommunication enhancement has been applied as the bolton to the authoritative profile that is specific to the client to which the independent mobile telecommunication enhancement operation is providing the mobile telecommunication enhancement such that a status of the bolton is switched.

In some examples of the first embodiment, wherein the application programming interface provides the independent mobile telecommunication enhancement operation with limited read/write access to an internal database that the mobile operator relies on as part of the mobile operator providing telecommunication services to the client.

In some examples of the first embodiment, the application programming interface is configured such that the application programming interface authenticates the independent mobile telecommunication enhancement operation prior to enabling the independent mobile telecommunication enhancement operation to proactively edit the field of the authoritative profile.

In some examples of the first embodiment, the application programming interface provides a graphical user interface to streamline a process of onboarding the independent mobile telecommunication enhancement operation with the mobile operator such that configuring how the mobile operator and the independent mobile telecommunication enhancement operation are integrated is performed by the independent mobile telecommunication enhancement operation.

In some examples of the first embodiment, the mobile operator charges for the mobile telecommunication enhancement and also for providing telecommunication service to the client in a same statement.

In some examples of the first embodiment, the application programming interface enables the independent mobile telecommunication enhancement operation to dynamically specify preferences that the independent mobile telecommunication enhancement operation has for subscribing to outbound communications from the mobile operator to the independent mobile telecommunication enhancement operation.

In some examples of the first embodiment, the application programming interface enables the independent mobile telecommunication enhancement operation to dynamically specify preferences that the independent mobile telecommunication enhancement operation has for subscribing to outbound communication from the mobile operator to the independent mobile telecommunication enhancement operation such that the preferences can vary according to different values of different respective variables including an event variable and a platform variable.

In some examples of the first embodiment, the event variable specifies between changes in a status of the client.

In some examples of the first embodiment, the event variable specifies between changes in the status of the client at least in part by specifying a switch from active to suspended status, a switch revoking suspension, a switch activating service, a switch deactivating service, a switch transferring to a distinct mobile network, or a switch from one device using a first mobile operating system platform and a second device having a second and distinct mobile operating system platform.

In some examples of the first embodiment, the application programming interface translates between data structures for fields that record mobile service operation details in a format that the mobile operator uses internally and second data structures for corresponding fields that record corresponding mobile service operation details in a distinct format that the independent mobile telecommunication enhancement operation uses internally.

In some examples of the first embodiment, the application programming interface enables the mobile operator to generate a data serialization language specification file for the independent mobile telecommunication enhancement operation that indicates outbound communication preferences of the independent mobile telecommunication enhancement operation based on input from the independent mobile telecommunication enhancement operation regarding outbound communication from the mobile operator to the independent mobile telecommunication enhancement operation.

In some examples of the first embodiment, the application programming interface generates a mapper file based on the data serialization language specification file for the independent mobile telecommunication enhancement operation and a distinct source data serialization language specification file for the mobile operator.

In some examples of the first embodiment, a system includes at least one physical computing processor and a non-transitory computer-readable medium that has instructions stored thereon that, when executed by the at least one physical computing processor, cause a computing device to perform operations comprising (i) identifying, by a mobile operator or an independent mobile telecommunication enhancement operation that provides a mobile telecommunication enhancement for clients of the mobile operator, an application programming interface that integrates the mobile operator with the independent mobile telecommunication enhancement operation such that the application programming interface enables the independent mobile telecommunication enhancement operation to proactively edit a field of an authoritative profile that is maintained by the mobile operator and that is specific to the independent mobile telecommunication enhancement operation or is specific to a client to which the independent mobile telecommunication enhancement operation is providing the mobile telecommunication enhancement and (ii) providing or accessing, by the mobile operator or the independent mobile telecommunication enhancement operation that provides the mobile telecommunication enhancement for clients of the mobile operator, the application programming interface that integrates the mobile operator with the independent mobile telecommunication enhancement operation such that the application programming interface enables the independent mobile telecommunication enhancement operation to proactively edit the field of the authoritative profile that is maintained by the mobile operator and that is specific to the independent mobile telecommunication enhancement operation or is specific to the client to which the independent mobile telecommunication enhancement operation is providing the mobile telecommunication enhancement.

In some examples of the first embodiment, a non-transitory computer-readable medium that has instructions stored thereon that, when executed by at least one physical computing processor, cause a computing device to perform operations comprising (i) identifying, by a mobile operator or an independent mobile telecommunication enhancement operation that provides a mobile telecommunication enhancement for clients of the mobile operator, an application programming interface that integrates the mobile operator with the independent mobile telecommunication enhancement operation such that the application programming interface enables the independent mobile telecommunication enhancement operation to proactively edit a field of an authoritative profile that is maintained by the mobile operator and that is specific to the independent mobile telecommunication enhancement operation or is specific to a client to which the independent mobile telecommunication enhancement operation is providing the mobile telecommunication enhancement and providing or accessing, by the mobile operator or the independent mobile telecommunication enhancement operation that provides the mobile telecommunication enhancement for clients of the mobile operator, the application programming interface that integrates the mobile operator with the independent mobile telecommunication enhancement operation such that the application programming interface enables the independent mobile telecommunication enhancement operation to proactively edit the field of the authoritative profile that is maintained by the mobile operator and that is specific to the independent mobile telecommunication enhancement operation or is specific to the client to which the independent mobile telecommunication enhancement operation is providing the mobile telecommunication enhancement.

In a second embodiment, a method includes (i) identifying, by a mobile operator or an independent mobile telecommunication enhancement operation that provides a mobile telecommunication enhancement for clients of the mobile operator, an application programming interface that integrates the mobile operator with the independent mobile telecommunication enhancement operation such that the application programming interface translates between data structures for fields that record mobile service operation details in a format that the mobile operator uses internally and second data structures for corresponding fields that record corresponding mobile service operation details in a distinct format that the independent mobile telecommunication enhancement operation uses internally, and (ii) providing or accessing, by the mobile operator or the independent mobile telecommunication enhancement operation that provides the mobile telecommunication enhancement for clients of the mobile operator, the application programming interface that integrates the mobile operator with the independent mobile telecommunication enhancement operation such that the application programming interface translates between the first data structures for fields that record mobile service operation details in the format that the mobile operator uses internally and the second data structures for corresponding fields that record corresponding mobile service operation details in the distinct format that the independent mobile telecommunication enhancement operation uses internally.

In examples of the second embodiment, the mobile telecommunication enhancement comprises a cable-television option, a secure Wi-Fi Internet connection option, an international calling option, a cloud storage option, a Voice Over Internet Protocol option, a streaming content service membership option, or a device insurance option.

In examples of the second embodiment, the application programming interface enables the independent mobile telecommunication enhancement operation to proactively edit a field of an authoritative profile that is maintained by the mobile operator and that is specific to the independent mobile telecommunication enhancement operation or is specific to a client to which the independent mobile telecommunication enhancement operation is providing the mobile telecommunication enhancement, and the field of the authoritative profile comprises a specification of whether the mobile telecommunication enhancement has been applied as a bolton to the authoritative profile that is specific to the client to which the independent mobile telecommunication enhancement operation is providing the mobile telecommunication enhancement.

In examples of the second embodiment, the method further comprises the independent mobile telecommunication enhancement operation editing the field of the authoritative profile comprising the specification of whether the mobile telecommunication enhancement has been applied as the bolton to the authoritative profile that is specific to the client to which the independent mobile telecommunication enhancement operation is providing the mobile telecommunication enhancement such that a status of the bolton is switched.

In examples of the second embodiment, the application programming interface provides the independent mobile telecommunication enhancement operation with limited read/write access to an internal database that the mobile operator relies on as part of the mobile operator providing telecommunication services to the clients.

In examples of the second embodiment, the application programming interface is configured such that the application programming interface authenticates the independent mobile telecommunication enhancement operation prior to enabling the independent mobile telecommunication enhancement operation to proactively edit a field of an authoritative profile that is maintained by the mobile operator and that is specific to the independent mobile telecommunication enhancement operation or is specific to a client to which the independent mobile telecommunication enhancement operation is providing the mobile telecommunication enhancement.

In examples of the second embodiment, the application programming interface provides a graphical user interface to streamline a process of onboarding the independent mobile telecommunication enhancement operation with the mobile operator such that configuring how the mobile operator and the independent mobile telecommunication enhancement operation are integrated is performed by the independent mobile telecommunication enhancement operation.

In examples of the second embodiment, the mobile operator charges for the mobile telecommunication enhancement and also for providing telecommunication service to a respective client in a same statement.

In examples of the second embodiment, the application programming interface enables the independent mobile telecommunication enhancement operation to dynamically specify preferences that the independent mobile telecommunication enhancement operation has for subscribing to outbound communications from the mobile operator to the independent mobile telecommunication enhancement operation.

In examples of the second embodiment, the application programming interface enables the independent mobile telecommunication enhancement operation to dynamically specify preferences that the independent mobile telecommunication enhancement operation has for subscribing to outbound communication from the mobile operator to the independent mobile telecommunication enhancement operation such that the preferences can vary according to different values of different respective variables including an event variable and a platform variable.

In examples of the second embodiment, the event variable specifies between changes in a status of the client.

In examples of the second embodiment, the event variable specifies between changes in the status of the client at least in part by specifying a switch from active to suspended status, a switch revoking suspension, a switch activating service, a switch deactivating service, a switch transferring to a distinct mobile network, or a switch from one device using a first mobile operating system platform and a second device having a second and distinct mobile operating system platform.

In examples of the second embodiment, the corresponding data structures for fields that record mobile service operation details in the format that the mobile operator uses internally and the second data structures for corresponding fields that record corresponding mobile service operation details in the distinct format that the independent mobile telecommunication enhancement operation uses to record internally at least two of the mobile station international subscriber directory number, the international mobile equipment identity, the subscriber identity module, the integrated circuit card identifier, a subscription status, an account balance, a roaming status, a device make, a device model, or an authentication credential.

In examples of the second embodiment, the application programming interface enables the mobile operator to generate a data serialization language specification file for the independent mobile telecommunication enhancement operation that indicates outbound communication preferences of the independent mobile telecommunication enhancement operation based on input from the independent mobile telecommunication enhancement operation regarding outbound communication from the mobile operator to the independent mobile telecommunication enhancement operation.

In examples of the second embodiment, the application programming interface generates a mapper file based on the data serialization language specification file for the independent mobile telecommunication enhancement operation and a distinct source data serialization language specification file for the mobile operator.

In examples of the second embodiment, the data serialization language specification file comprises a YAML file.

In examples of the second embodiment, a system comprises at least one physical computing processor and a non-transitory computer-readable medium that has instructions stored thereon that, when executed by the at least one physical computing processor, cause a computing device to perform operations comprising (i) identifying, by a mobile operator or an independent mobile telecommunication enhancement operation that provides a mobile telecommunication enhancement for clients of the mobile operator, an application programming interface that integrates the mobile operator with the independent mobile telecommunication enhancement operation such that the application programming interface translates between data structures for fields that record mobile service operation details in a format that the mobile operator uses internally and second data structures for corresponding fields that record corresponding mobile service operation details in a distinct format that the independent mobile telecommunication enhancement operation uses internally and (ii) providing or accessing, by the mobile operator or the independent mobile telecommunication enhancement operation that provides the mobile telecommunication enhancement for clients of the mobile operator, the application programming interface that integrates the mobile operator with the independent mobile telecommunication enhancement operation such that the application programming interface translates between the first data structures for fields that record mobile service operation details in the format that the mobile operator uses internally and the second data structures for corresponding fields that record corresponding mobile service operation details in the distinct format that the independent mobile telecommunication enhancement operation uses internally.

In examples of the second embodiment, a non-transitory computer-readable medium has instructions stored thereon that, when executed by at least one physical computing processor, cause a computing device to perform operations comprising: (i) identifying, by a mobile operator or an independent mobile telecommunication enhancement operation that provides a mobile telecommunication enhancement for clients of the mobile operator, an application programming interface that integrates the mobile operator with the independent mobile telecommunication enhancement operation such that the application programming interface translates between data structures for fields that record mobile service operation details in a format that the mobile operator uses internally and second data structures for corresponding fields that record corresponding mobile service operation details in a distinct format that the independent mobile telecommunication enhancement operation uses internally and (ii) providing or accessing, by the mobile operator or the independent mobile telecommunication enhancement operation that provides the mobile telecommunication enhancement for clients of the mobile operator, the application programming interface that integrates the mobile operator with the independent mobile telecommunication enhancement operation such that the application programming interface translates between the first data structures for fields that record mobile service operation details in the format that the mobile operator uses internally and the second data structures for corresponding fields that record corresponding mobile service operation details in the distinct format that the independent mobile telecommunication enhancement operation uses internally.

In a third embodiment, a method comprises: (i) identifying, by a mobile operator with clients for which an independent mobile telecommunication enhancement operation provides a mobile telecommunication enhancement, a mapper file that specifies how to customize outbound communication messages based on a data serialization language specification file for the independent mobile telecommunication enhancement operation that indicates outbound communication preferences of the independent mobile telecommunication enhancement operation that was generated based on input from the independent mobile telecommunication enhancement operation regarding outbound communication from the mobile operator to the independent mobile telecommunication enhancement operation and (ii) applying, by the mobile operator with the clients for which the independent mobile telecommunication enhancement operation provides the mobile telecommunication enhancement, the mapper file to an event detected by the mobile operator such that the mobile operator automatically reports the event to the independent mobile telecommunication enhancement operation that provides the mobile telecommunication enhancement for the clients of the mobile operator in a manner that conforms to the outbound communication preferences of the independent mobile telecommunication enhancement operation as indicated by the data serialization language specification file for the independent mobile telecommunication enhancement operation regarding outbound communication from the mobile operator to the independent mobile telecommunication enhancement operation.

In examples of the third embodiment, the mobile telecommunication enhancement comprises a cable-television option, a secure Wi-Fi Internet connection option, an international calling option, a cloud storage option, a Voice Over Internet Protocol option, a streaming content service membership option, or a device insurance option.

In examples of the third embodiment, the mobile operator provides an application programming interface that enables the independent mobile telecommunication enhancement operation to proactively edit a field of an authoritative profile that is maintained by the mobile operator and that is specific to the independent mobile telecommunication enhancement operation or is specific to a client to which the independent mobile telecommunication enhancement operation is providing the mobile telecommunication enhancement, and the field of the authoritative profile comprises a specification of whether the mobile telecommunication enhancement has been applied as a bolton to the authoritative profile that is specific to the client to which the independent mobile telecommunication enhancement operation is providing the mobile telecommunication enhancement.

In examples of the third embodiment, the method further comprises the independent mobile telecommunication enhancement operation editing the field of the authoritative profile comprising the specification of whether the mobile telecommunication enhancement has been applied as the bolton to the authoritative profile that is specific to the client to which the independent mobile telecommunication enhancement operation is providing the mobile telecommunication enhancement such that a status of the bolton is switched.

In examples of the third embodiment, the mobile operator provides the independent mobile telecommunication enhancement operation with an application programming interface that further provides the independent mobile telecommunication enhancement operation with limited read/write access to an internal database that the mobile operator relies on as part of the mobile operator providing telecommunication services to the clients.

In examples of the third embodiment, the mobile operator provides the independent mobile telecommunication enhancement operation with an application programming interface that authenticates the independent mobile telecommunication enhancement operation prior to enabling the independent mobile telecommunication enhancement operation to proactively edit a field of an authoritative profile that is maintained by the mobile operator and that is specific to the independent mobile telecommunication enhancement operation or is specific to a client to which the independent mobile telecommunication enhancement operation is providing the mobile telecommunication enhancement.

In examples of the third embodiment, the mobile operator provides the independent mobile telecommunication enhancement operation with an application programming interface that further provides a graphical user interface to streamline a process of onboarding the independent mobile telecommunication enhancement operation with the mobile operator such that configuring how the mobile operator and the independent mobile telecommunication enhancement operation are integrated is performed by the independent mobile telecommunication enhancement operation.

In examples of the third embodiment, the mobile operator charges for the mobile telecommunication enhancement and also for providing telecommunication service to a respective client in a same statement.

In examples of the third embodiment, the mobile operator provides the independent mobile telecommunication enhancement operation with an application programming interface that enables the independent mobile telecommunication enhancement operation to dynamically specify the outbound communication preferences that the independent mobile telecommunication enhancement operation has for subscribing to outbound communications from the mobile operator to the independent mobile telecommunication enhancement operation.

In examples of the third embodiment, the application programming interface enables the independent mobile telecommunication enhancement operation to dynamically specify preferences that the independent mobile telecommunication enhancement operation has for subscribing to outbound communication from the mobile operator to the independent mobile telecommunication enhancement operation such that the preferences can vary according to different values of different respective variables including an event variable and a platform variable.

In examples of the third embodiment, the event variable specifies between changes in a status of a client.

In examples of the third embodiment, the event variable specifies between changes in the status of the client at least in part by specifying a switch from active to suspended status, a switch revoking suspension, a switch activating service, a switch deactivating service, a switch transferring to a distinct mobile network, or a switch from one device using a first mobile operating system platform and a second device having a second and distinct mobile operating system platform.

In examples of the third embodiment, the mobile operator provides the independent mobile telecommunication enhancement operation with an application programming interface that translates between data structures for fields that record mobile service operation details in a format that the mobile operator uses internally and second data structures for corresponding fields that record corresponding mobile service operation details in a distinct format that the independent mobile telecommunication enhancement operation uses internally, and the corresponding data structures record at least two of the mobile station international subscriber directory number, the international mobile equipment identity, the subscriber identity module, the integrated circuit card identifier, a subscription status, an account balance, a roaming status, a device make, a device model, or an authentication credential.

In examples of the third embodiment, the mobile operator provides the independent mobile telecommunication enhancement operation with an application programming interface that enables the mobile operator to generate a data serialization language specification file for the independent mobile telecommunication enhancement operation that indicates the outbound communication preferences of the independent mobile telecommunication enhancement operation based on input from the independent mobile telecommunication enhancement operation regarding outbound communication from the mobile operator to the independent mobile telecommunication enhancement operation.

In examples of the third embodiment, the application programming interface generates the mapper file based on the data serialization language specification file for the independent mobile telecommunication enhancement operation and a distinct source data serialization language specification file for the mobile operator.

In examples of the third embodiment, the data serialization language specification file comprises a YAML file.

In examples of the third embodiment, a system includes at least one physical computing processor and a non-transitory computer-readable medium that has instructions stored thereon that, when executed by the at least one physical computing processor, cause a computing device to perform operations comprising: (i) identifying, by a mobile operator with clients for which an independent mobile telecommunication enhancement operation provides a mobile telecommunication enhancement, a mapper file that specifies how to customize outbound communication messages based on a data serialization language specification file for the independent mobile telecommunication enhancement operation that indicates outbound communication preferences of the independent mobile telecommunication enhancement operation that was generated based on input from the independent mobile telecommunication enhancement operation regarding outbound communication from the mobile operator to the independent mobile telecommunication enhancement operation, and (ii) applying, by the mobile operator with the clients for which the independent mobile telecommunication enhancement operation provides the mobile telecommunication enhancement, the mapper file to an event detected by the mobile operator such that the mobile operator automatically reports the event to the independent mobile telecommunication enhancement operation that provides the mobile telecommunication enhancement for the clients of the mobile operator in a manner that conforms to the outbound communication preferences of the independent mobile telecommunication enhancement operation as indicated by the data serialization language specification file for the independent mobile telecommunication enhancement operation regarding outbound communication from the mobile operator to the independent mobile telecommunication enhancement operation.

In examples of the third embodiment, a non-transitory computer-readable medium has instructions stored thereon that, when executed by at least one physical computing processor, cause a computing device to perform operations comprising: (i) identifying, by a mobile operator with clients for which an independent mobile telecommunication enhancement operation provides a mobile telecommunication enhancement, a mapper file that specifies how to customize outbound communication messages based on a data serialization language specification file for the independent mobile telecommunication enhancement operation that indicates outbound communication preferences of the independent mobile telecommunication enhancement operation that was generated based on input from the independent mobile telecommunication enhancement operation regarding outbound communication from the mobile operator to the independent mobile telecommunication enhancement operation, and (ii) applying, by the mobile operator with the clients for which the independent mobile telecommunication enhancement operation provides the mobile telecommunication enhancement, the mapper file to an event detected by the mobile operator such that the mobile operator automatically reports the event to the independent mobile telecommunication enhancement operation that provides the mobile telecommunication enhancement for the clients of the mobile operator in a manner that conforms to the outbound communication preferences of the independent mobile telecommunication enhancement operation as indicated by the data serialization language specification file for the independent mobile telecommunication enhancement operation regarding outbound communication from the mobile operator to the independent mobile telecommunication enhancement operation.

### BRIEF DESCRIPTION OF THE DRAWINGS

For a better understanding of the present invention, reference will be made to the following Detailed Description, which is to be read in association with the accompanying drawings:

FIG. 1 shows a flow diagram for a method relating to an independent mobile telecommunication enhancement operation integration platform.

FIG. 2A shows a diagram of a retail wireless value-added service platform.

FIG. 2B shows a diagram of a graphical user interface for a value-added service provider to use the application programming interface.

FIG. 2C shows a diagram of the graphical user interface enabling new value-added service provider onboarding.

FIG. 2D shows a diagram of the graphical user interface enabling a value-added service provider to perform actions with respect to various secure Wi-Fi products or services.

FIG. 2E shows a diagram of the graphical user interface enabling the value-added service provider to perform actions with respect to various international calling plan products or services.

FIG. 2F shows a diagram of the graphical user interface enabling the value-added service provider to perform actions with respect to different subscribers.

FIG. 3 shows a diagram of a subscription application programming interface.

FIG. 4 shows a diagram of an outbound communication account status change application programming interface as well as an outbound communication application programming interface for adding or removing a bolton.

FIG. 5 shows a diagram of an inbound communication management architecture.

FIG. 6 shows a diagram of an outbound communication management architecture.

FIG. 7 shows a diagram of a transaction log.

FIG. 8 shows a flow diagram for another method relating to an independent mobile telecommunication enhancement operation integration platform

FIG. 9 shows a diagram indicating how mobile service operation details may be stored in different formats for different value-added service providers.

FIG. 10 shows a diagram indicating how a mobile operator may standardize the mobile service operation details.

FIG. 11 shows a diagram further indicating how mobile service operation details may be stored in different formats for different value-added service providers.

FIG. 12 shows a flow diagram for another method relating to an independent mobile telecommunication enhancement operation integration platform

FIG. 13 shows a diagram of a graphical user interface indicating how value-added service providers may dynamically specify preferences for subscribing to event notifications regarding changes in status for a particular subscriber.

FIG. 14 shows a diagram indicating how a mobile operator and a corresponding value-added service provider may use two different data serialization language specification files, respectively.

FIG. 15 shows a diagram indicating how different value-added service providers may upload respective data serialization language specification files to a corresponding web server for retrieval by a particular mobile operator.

FIG. 16 shows a diagram indicating how a uniform resource locator may be dynamically generated or analyzed such that a single value-added service provider can store multiple distinct data serialization language specification files on a corresponding web server for retrieval by a particular mobile operator.

FIG. 17 shows a diagram indicating a workflow for rules-driven processing of events for outbound notifications to corresponding value-added service providers.

FIG. 18 shows a diagram indicating a workflow for generating a mapper file based on two respective data serialization language specification files.

FIG. 19 shows a diagram of an example computing system that may facilitate the performance of one or more of the methods described herein.

### DETAILED DESCRIPTION

The following description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure, including but not limited to the communication systems and networks, have not been shown or described in order to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

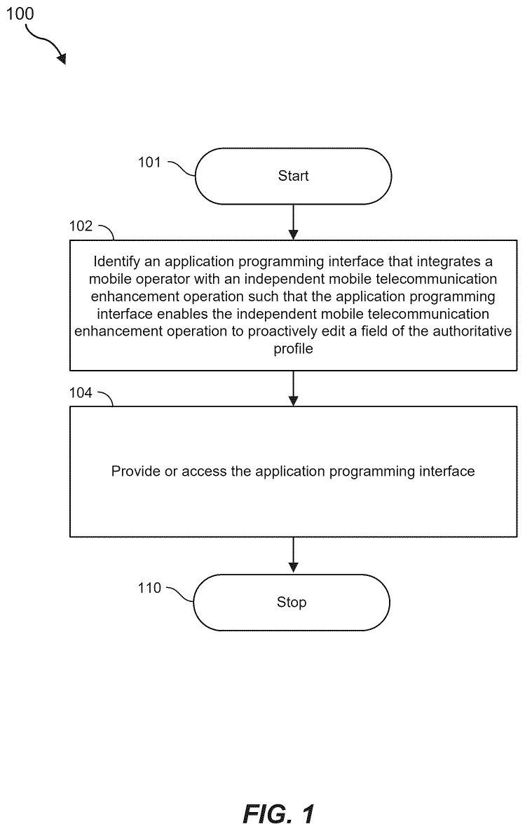

FIG. 1 shows a flow diagram for a method 100 relating to an independent mobile telecommunication enhancement operation integration platform. At step 101 method 100 may start or begin. At step 102, method 100 may include identifying, by a mobile operator or an independent mobile telecommunication enhancement operation that provides a mobile telecommunication enhancement for clients of the mobile operator, an application programming interface that integrates the mobile operator with the independent mobile telecommunication enhancement operation such that the application programming interface enables the independent mobile telecommunication enhancement operation to proactively edit a field of an authoritative profile that is maintained by the mobile operator and that is specific to the independent mobile telecommunication enhancement operation or is specific to a client to which the independent mobile telecommunication enhancement operation is providing the mobile telecommunication enhancement. At step 104, method 100 may include providing or accessing, by the mobile operator or the independent mobile telecommunication enhancement operation that provides the mobile telecommunication enhancement for clients of the mobile operator, the application programming interface that integrates the mobile operator with the independent mobile telecommunication enhancement operation such that the application programming interface enables the independent mobile telecommunication enhancement operation to proactively edit the field of the authoritative profile that is maintained by the mobile operator and that is specific to the independent mobile telecommunication enhancement operation or is specific to the client to which the independent mobile telecommunication enhancement operation is providing the mobile telecommunication enhancement. At step 110, method 100 may stop or conclude.

As used herein, the term “authoritative profile” generally refers to a primary or reliable profile that the mobile operator relies on for operating purposes. By way of illustrative example, the mobile operator will generally maintain a profile describing attributes of the value-added service provider and the mobile operator will also generally maintain a profile describing any client, customer, or subscriber. For example, the mobile operator may maintain a profile that establishes the name, address, and/or contact information for the value-added service provider, as well as its services, products, and/or subscribers associated with that particular provider. Similarly, the mobile operator will generally maintain a profile that establishes the name, address, and/or billing information for a particular subscriber. In view of the above, method 100 can refer to the mobile operator providing an application programming interface that enables the value-added service provider to edit one or more of these fields directly within the mobile operator's own database, thereby providing the value-added service provider with limited read/write abilities with respect to the mobile operator's database. As another example, when the provider decides to end a subscription for a particular subscriber, the provider can update this information directly within the mobile operator's database. Similarly, when the provider decides to update the price point for a particular product or service, the provider can update this information directly within the operator's database. In this manner, the provider can proactively update any one or more of these various fields or items of data, thereby shifting this burden from the mobile operator to the provider itself and furthermore streamlining operations by eliminating the mobile operator as an effective middleman, as further discussed below.

As used herein, the term “independent mobile telecommunication enhancement operation” can generally refer to a value-added service provider for a mobile operator. The operation may be “independent” in the sense that it refers to a third-party that is logically distinct from the mobile operator and the client. A value-added service provider (VASP) in the context of a mobile operator can refer to a third-party company that partners with the mobile operator to offer additional products or services that enhance the core offerings of the mobile operator, thereby delivering greater value to the customers. These services go beyond the standard voice, messaging, and data services provided by the mobile operator and can include a wide range of options such as streaming subscriptions (e.g., Netflix membership), secure Wi-Fi access, cloud storage solutions, gaming services, and more. The value-added service provider integrates their offerings into the mobile operator's ecosystem, allowing customers to access these enhanced services directly through their mobile network. One of the key conveniences provided by this arrangement is unified billing, where the charges for the value-added services are consolidated with the customer's regular mobile service bill. This means that customers receive a single, comprehensive bill from their mobile operator, which includes the cost of both their standard mobile services and the additional services provided by the value-added service provider. This integration simplifies the user experience, as customers do not need to manage multiple bills or payment systems. Instead, they can enjoy a range of enhanced services with the convenience of one point of contact and billing. For the mobile operator, partnering with value-added service providers helps differentiate their offerings in a competitive market, attract new customers, and retain existing ones by providing a richer, more diversified service portfolio. Moreover, as used herein, the term “mobile telecommunication enhancement” can refer to a value-added service, consistent with the above discussion.

As used here, the term “mobile operator” can generally include a mobile network operator and/or a mobile virtual network operator, for example. A mobile network operator and a mobile virtual network operator can play complementary roles in the telecommunications ecosystem. A mobile network operator generally owns and operates the full infrastructure required to provide wireless communication services. This includes acquiring spectrum licenses from the government, building and maintaining cell towers, deploying the necessary hardware and software for network management, and ensuring comprehensive customer support and billing systems. Mobile network operators can invest heavily in the development and maintenance of this infrastructure, allowing them to control all aspects of their service delivery, including network performance, coverage, and quality. They can also engage in large-scale marketing and sales operations to attract and retain subscribers.

A mobile virtual network operator generally enters into agreements with one or more mobile network operators to access their network services at wholesale rates. Mobile virtual network operators then resell these services to their own customers under their brand, often focusing on specific market niches or offering differentiated service packages. For example, a mobile virtual network operator might target budget-conscious consumers with lower-cost plans, international travelers with specialized roaming packages, or tech-savvy users with added features such as enhanced data management tools. Mobile virtual network operators can invest in their own customer support, marketing, and billing systems to create a unique customer experience. The primary difference between the two lies in their business models and operational scopes. Mobile network operators are capital-intensive and control the physical network, which requires significant ongoing investments in technology upgrades and maintenance. This control allows them to offer potentially better service quality and coverage. Mobile virtual network operators, on the other hand, operate with lower overhead costs since they lease rather than build infrastructure. This can enable them to be more flexible and innovative with their service offerings and pricing models, catering to specific consumer segments that might be underserved by traditional mobile network operators. Both types of operators contribute to the diversity and competitiveness of the mobile telecommunications market, providing consumers with a wide range of choices in terms of services, pricing, and customer experiences. In some examples, a single company can acquire or develop both services such that the company effectively becomes both a mobile network operator and a mobile virtual network operator.

As used herein, an “application programming interface,” can refer to a set of rules or protocols that allows different software applications to communicate with each other. In the context of value-added service providers working with a mobile operator, an application programming interface can serve as an intermediary that enables these external services to interact with the mobile operator's systems.

For example, when a value-added service provider, such as a company offering a streaming service or secure Wi-Fi, wants to integrate their service with a mobile operator, the provider can use an application programming interface that is provided by the mobile operator. This application programming interface can include various endpoints and methods that the service provider can call to perform specific actions. These actions might include logging in, verifying user identities, accessing billing information, or managing subscriptions.

When a value-added service provider tries to log in to a mobile operator's system, the provider can use the application programming interface to send a request, typically containing necessary authentication credentials such as an application programming interface key and/or token. The mobile operator's application programming interface can receive this request, authenticate the credentials, and then grant access to the service provider to interact with relevant data and services. As outlined above, this overall process can ensure secure and controlled access, maintaining the integrity and privacy of the mobile operator's data and systems. In view of the above, application programming interfaces can play a role in enabling value-added service providers to offer their products or services through the mobile operator's platform. They allow for efficient and secure integration, ensuring that end-users can access and manage these additional services smoothly, often with the convenience of a unified billing system. The interaction facilitated by such application programming interfaces can enhance the overall user experience by providing diverse services in a coherent and streamlined manner.

As used herein, the phrase “proactively edit” can generally refer to the value-added service provider initiating the edit or freely editing the field without necessarily being prompted or requested to do so by the mobile operator. In other words, after the value-added service provider successfully authenticates with the application programming interface, the value-added service provider may initiate and successfully complete the edit of the field of the authoritative profile. By way of illustrative example, the value-added service provider may update the price point for a particular product or service, such as by increasing the price point, and may then authenticate into the application programming interface and proactively edit the price point. In such examples, the mobile operator may not necessarily prompt or request for the value-added service provider to edit the field of the authoritative profile and, instead, the mobile operator may first learn about the update to the price point in response to the value-added service provider proactively editing the fields of the authoritative profile.

In some examples of the first embodiment, the mobile telecommunication enhancement comprises a cable-television option, a secure Wi-Fi Internet connection option, an international calling option, a cloud storage option, a Voice Over Internet Protocol option, a streaming content service membership option, or a device insurance option. A cable company can enhance the offerings of a mobile operator by acting as a value-added service provider. By partnering with the mobile operator, the company can provide its extensive library of premium television shows, movies, and original content to the mobile operator's customers. This collaboration allows users to access the content directly through their mobile devices, with the convenience of a single bill from their mobile operator that includes both their mobile service and cable company subscription. This integration can be achieved through the mobile operator's application programming interface, enabling access and authentication for customers.

In some examples of the first embodiment, the field of the authoritative profile comprises a specification of whether the mobile telecommunication enhancement has been applied as a bolton to the authoritative profile that is specific to the client to which the independent mobile telecommunication enhancement operation is providing the mobile telecommunication enhancement. In further examples, method 100 further includes the independent mobile telecommunication enhancement operation editing the field of the authoritative profile comprising the specification of whether the mobile telecommunication enhancement has been applied as the bolton to the authoritative profile that is specific to the client to which the independent mobile telecommunication enhancement operation is providing the mobile telecommunication enhancement such that a status of the bolton is switched. As used herein, the term “bolton” can be used, consistent with the usage of those having skill in the art, to indicate a recurring charge that is automatically applied to the client by the mobile operator to charge for the particular product or service that the value-added service provider provides through the mobile operator. By way of illustrative example, a streaming content platform may provide a membership at a discounted rate through the mobile operator, and this value-added service may be charged, as a bolton, such that the charge automatically recurs until manually removed or the client intervenes. Accordingly, in some examples of method 100, the value-added service provider retains the option to toggle a bolton on or off directly in the mobile operator's database. Additionally, or alternatively, in other examples the value-added service partner retains read visibility into the variable specifying whether the bolton has been toggled on or off, and may furthermore optionally request for the status of the bolton to be switched, without necessarily retaining read/write access to proactively edit this variable itself.

As another example, a value-added service provider can enhance a mobile operator's offerings by providing international calling services to its customers. By integrating with the mobile operator's existing network infrastructure through a secure application programming interface, the service provider can offer competitively priced international call packages. These packages allow users to make high-quality voice calls to a wide range of international destinations, directly from their mobile phones, without the need for additional apps or complex dialing procedures. The charges for these international calls are conveniently included in the customer's regular mobile bill, streamlining the payment process and providing a user experience. This partnership enables the mobile operator to attract and retain customers who have a need for frequent international communication, such as expatriates, business travelers, and multicultural families, while the value-added service provider gains access to a broader customer base through the mobile operator's extensive market presence.

Similarly, a value-added service provider can significantly enhance a mobile operator's service portfolio by offering cloud storage solutions to its customers. Through integration with the mobile operator's platform via one or more secure application programming interfaces, the service provider can provide cloud storage services directly to the mobile operator's customers. This integration enables users to easily store, access, and share their files, documents, photos, and videos across multiple devices, including smartphones, tablets, and computers.

As a last example, a value-added service provider can greatly enrich the offerings of a mobile operator by extending mobile device insurance services to its customers. Through integration with the mobile operator's platform using one or more secure application programming interfaces, the service provider can offer robust insurance coverage for mobile devices directly to the operator's clientele. This integration simplifies the insurance acquisition process, allowing users to conveniently add coverage for their devices during activation or at any subsequent point. Leveraging the mobile operator's existing billing infrastructure, the cost of device insurance integrates into the customer's regular mobile bill, streamlining payment and ensuring a hassle-free experience. This partnership not only bolsters the mobile operator's service value but also fosters customer loyalty and satisfaction by providing security and financial protection against loss, theft, or damage to their mobile devices.

In addition to the value-added services mentioned earlier, mobile operators have a plethora of other options to enhance their offerings and cater to various customer preferences. One such example is personalized entertainment content, such as curated playlists, audiobooks, or digital magazines, tailored to individual tastes and interests. These services provide users with a convenient and immersive entertainment experience directly through their mobile devices, allowing them to enjoy their favorite content on the go. Furthermore, mobile operators can partner with third-party gaming companies to offer a wide variety of mobile games, ranging from casual puzzles to immersive multiplayer experiences. These gaming options can provide entertainment and engagement for users of all ages and interests, fostering customer satisfaction and loyalty. Additionally, mobile operators can explore partnerships with music streaming platforms to offer premium music subscriptions, enabling users to access millions of songs and playlists ad-free, offline, and on-demand. This value-added service can enhance the mobile operator's value proposition, attracting music enthusiasts and enhancing user retention. Moreover, mobile operators can collaborate with digital content creators to provide exclusive access to premium digital content, such as virtual events, live concerts, or behind-the-scenes footage.

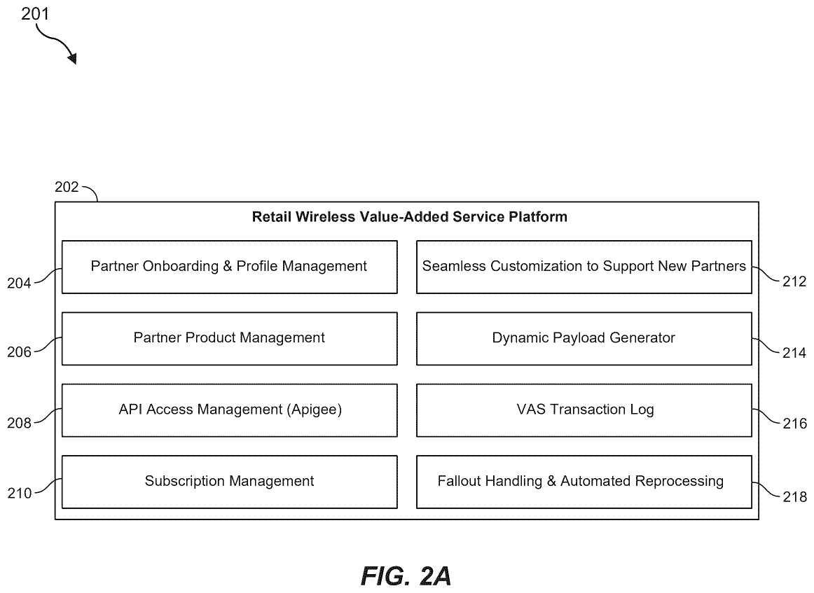

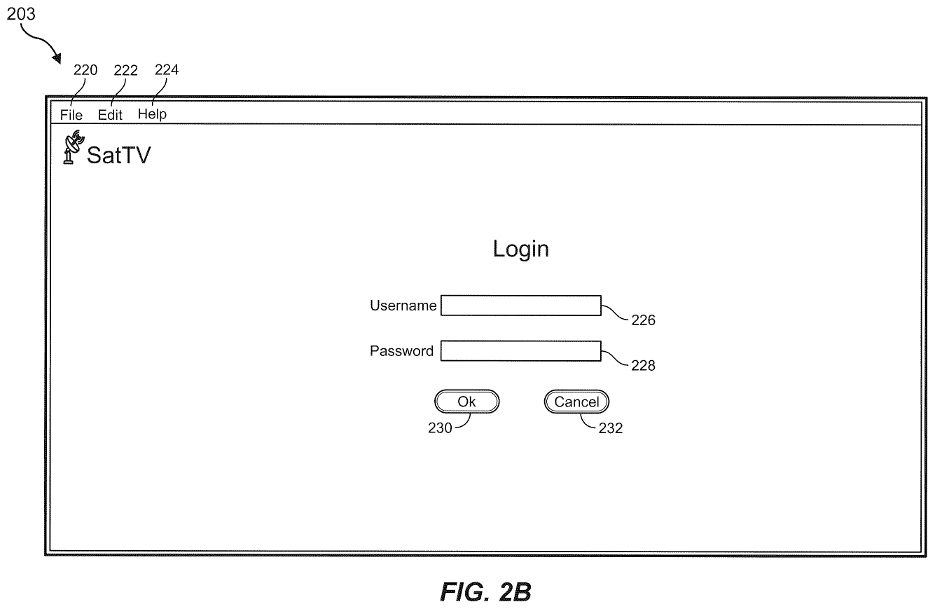

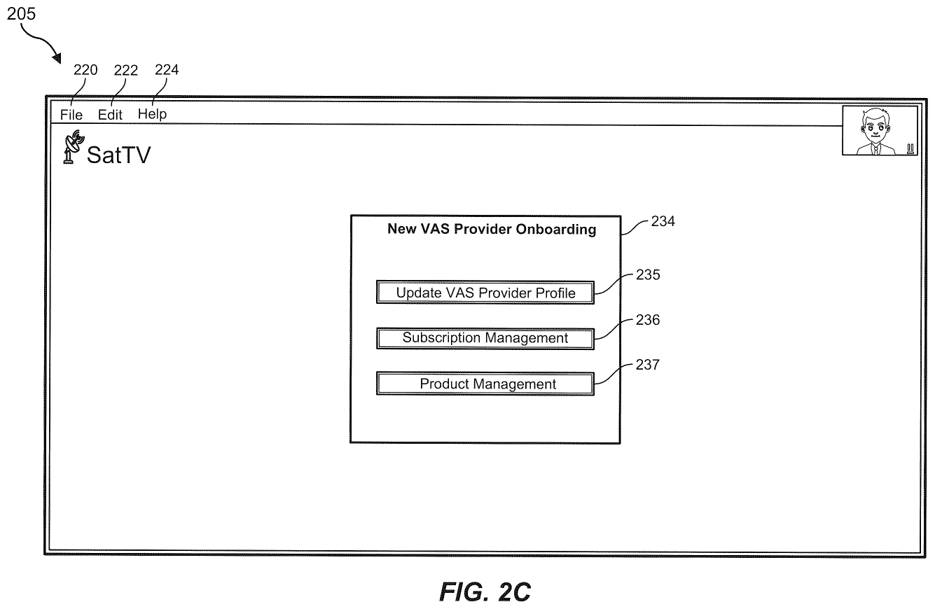

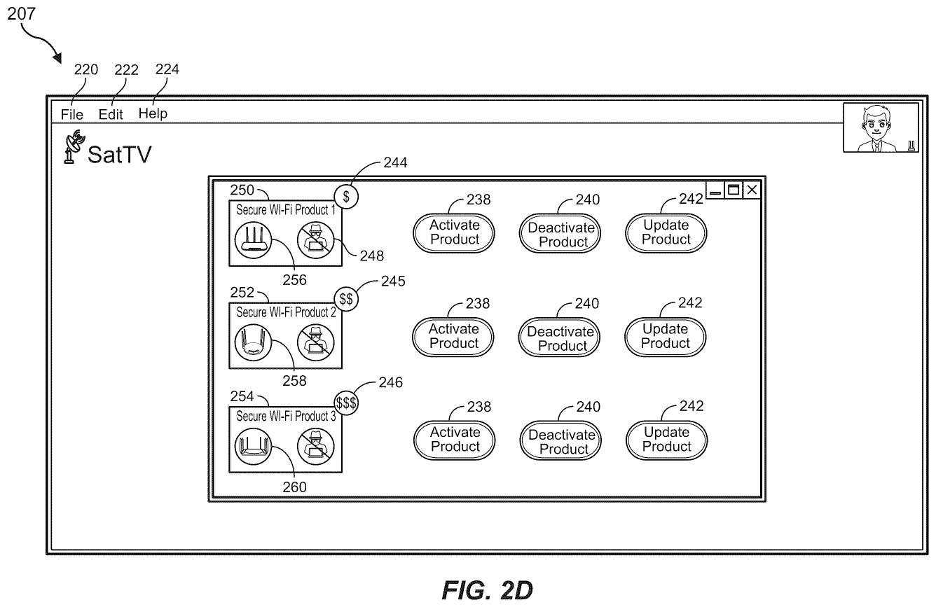

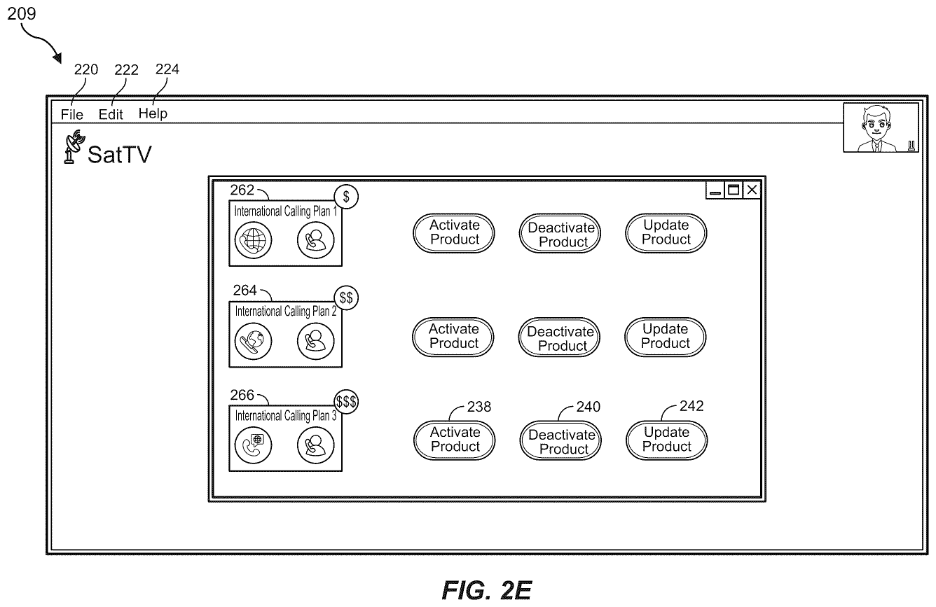

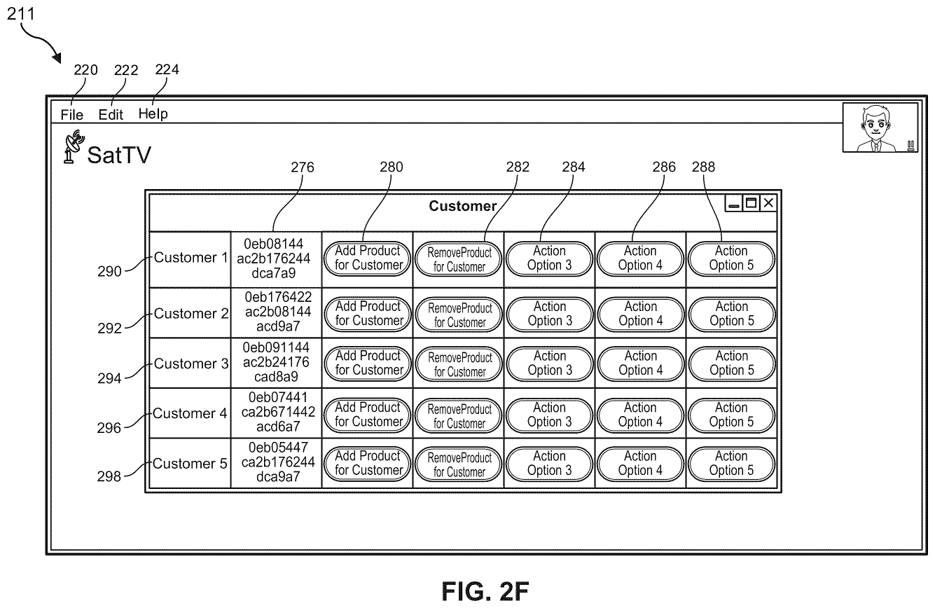

FIG. 2A shows a diagram 201 of a retail wireless value-added service platform 202, which can correspond to the application programming interface described above. Retail wireless value-added service platform 202 can include partner onboarding and profile management 204, partner product management 206, application programming interface access management 208, subscription management 210, seamless customization to support new partners 212, a dynamic payload generator 214, a value-added service transaction log 216, and/or fallout handling and automated reprocessing 218. The benefits and procedures associated with these various features are described in more detail below.

Regarding partner onboarding and profile management 204, when integrating with a mobile operator's application programming interface, a value-added service provider may input one or more items from a diverse array of information to accurately describe the partner and its preferences, enabling seamless collaboration and service delivery. One such item of information can include partner identification information, including the partner's name, legal entity details, and contact information. This ensures clear communication channels and establishes the partner's identity within the mobile operator's ecosystem. Additionally, partner preferences, such as preferred communication methods, billing arrangements, and service activation protocols, help tailor the integration process to meet the partner's specific needs and expectations. Partner branding elements, such as logos, colors, and brand guidelines, ensure consistent representation across platforms and maintain brand integrity. Technical specifications, such as application programming interface endpoints, authentication methods, and data formatting requirements, can provide clarity on integration protocols and facilitate smooth data exchange between the partner and the mobile operator. Service level agreements, including uptime guarantees, support response times, and data security protocols, can outline the terms of engagement and ensure mutual accountability for service quality and performance. Payment preferences, such as billing cycles, payment methods, and revenue-sharing agreements, can establish financial arrangements and streamline transaction processes between the partner and the mobile operator. Furthermore, preferences related to customer data handling, privacy policies, and regulatory compliance ensure adherence to legal and ethical standards, safeguarding customer information and maintaining trust.

Regarding partner product management 206, when integrating with a mobile operator's application programming interface, a value-added service provider can input a comprehensive array of information to accurately describe the various products and services that it offers, along with associated metadata and codes. These items of information can include pictures, detailed descriptions, specifications, and/or features of each offering. This enables customers and/or the mobile operator to understand the value proposition and functionalities of the products or services, aiding in informed decision-making. Additionally, product metadata, such as categories, tags, and keywords, enhances discoverability and organization, making it easier for customers and/or the mobile operator to find and understand relevant offerings. Codes associated with each product, such as SKU (Stock Keeping Unit) numbers or UPC (Universal Product Code) identifiers, ensure accurate tracking and inventory management, streamlining operations and logistics. Pricing information, including base prices, discounts, and promotions, can allow customers to assess the cost-effectiveness of each product or service, enabling transparent transactions. Furthermore, metadata related to product status, such as availability, activation status, and subscription renewal dates, can provide real-time insights into the lifecycle of offerings, facilitating proactive management and timely interventions when necessary. Usage codes or metrics, such as data allowances, call minutes, or message counts, can offer insights into customer behavior and preferences, informing service improvements and customization efforts. Overall, by inputting one or more of these various pieces of information into the mobile operator's application programming interface, the value-added service provider can ensure accurate representation and effective management of products and services.

Regarding application programming interface access management 208, the application programming interface can be managed through an application programming interface management and predictive analytics software provider such as Apigee. An application programming interface and predictive analytics tool, service, and/or company can serve as an intermediary between businesses and their digital ecosystems, providing tools and services to optimize operations and drive growth. Application programming interface management can involve providing a robust platform and suite of tools to help businesses create, deploy, manage, and secure application programming interface. This can entail facilitating integration and communication between various applications, systems, and devices, both internally within an organization and externally with partners and customers. Application programming interface management solutions can include features such as application programming interface design and development tools, application programming interface gateway and security mechanisms, application programming interface lifecycle management, monitoring and analytics capabilities, and developer portals for documentation and collaboration. By centralizing application programming interface management processes, the service enables businesses to streamline operations, accelerate innovation, and improve agility in adapting to evolving market demands.

In addition to application programming interface management, application programming interface access management 208 can provide predictive analytics, leveraging advanced algorithms and machine learning techniques to extract insights from data and forecast future trends, behaviors, and outcomes. This can involve collecting and analyzing vast amounts of structured and unstructured data from various sources, including transactional records, customer interactions, social media activity, and sensor data. Through sophisticated data modeling and analysis, the service can identify patterns, correlations, and anomalies within the data to generate actionable insights and predictive models. These predictive analytics solutions can enable businesses to anticipate customer needs and preferences, optimize resource allocation and decision-making, mitigate risks, and seize opportunities for innovation and growth.

In the mobile context of this disclosure, an application programming interface management and predictive analytics service can offer tailored solutions to optimize the integration process for a value-added service provider accessing an application programming interface provided by a mobile operator. In this scenario, the service can provide a comprehensive application programming interface management platform that enables integration and efficient management of subscriptions to the value-added services offered through the mobile operator's platform. It can facilitate the design and development of application programming interfaces that meet the specific requirements of the service provider and the mobile operator, offering tools and templates to create application programming interface specifications, define endpoints, and establish authentication mechanisms tailored to the integration scenario. This can ensure compatibility and interoperability between the service provider's systems and the mobile operator's platform. Additionally, the service can ensure robust security and access control measures to protect sensitive subscriber data and prevent unauthorized access, implementing authentication and authorization mechanisms to authenticate users and enforce access policies based on roles and permissions. Comprehensive monitoring and analytics capabilities can track application programming interface usage, performance metrics, and subscriber behavior in real-time, providing dashboards and reports to visualize key metrics, forecast future trends, and identify opportunities for service improvement and revenue growth. Furthermore, seamless integration with the mobile operator's billing and payment systems enables automated billing processes, subscription management, and revenue reconciliation, streamlining administrative tasks and reducing operational overhead.

Regarding subscription management 210, retail wireless value-added service platform 202 may enable the provider to input or manage items of subscriber-related information, including details such as names, contact information, and account identifiers. This enables the service provider to identify and authenticate subscribers, ensuring personalized communication and support. Additionally, subscription details can include the subscribed services, subscription duration, and pricing plans. This allows the service provider to accurately track which services each subscriber has opted for, how long they have been subscribed, and the associated costs. Transactional data, such as payment history, billing cycles, and invoice details, helps manage subscription renewals, track revenue streams, and ensure timely payments. Furthermore, activity levels provide insights into subscriber engagement and usage patterns, enabling the service provider to tailor offerings and promotions to suit individual preferences. Metadata items, including subscription tags, categories, or plan codes, facilitate organization and categorization, making it easier to manage a large subscriber base efficiently.

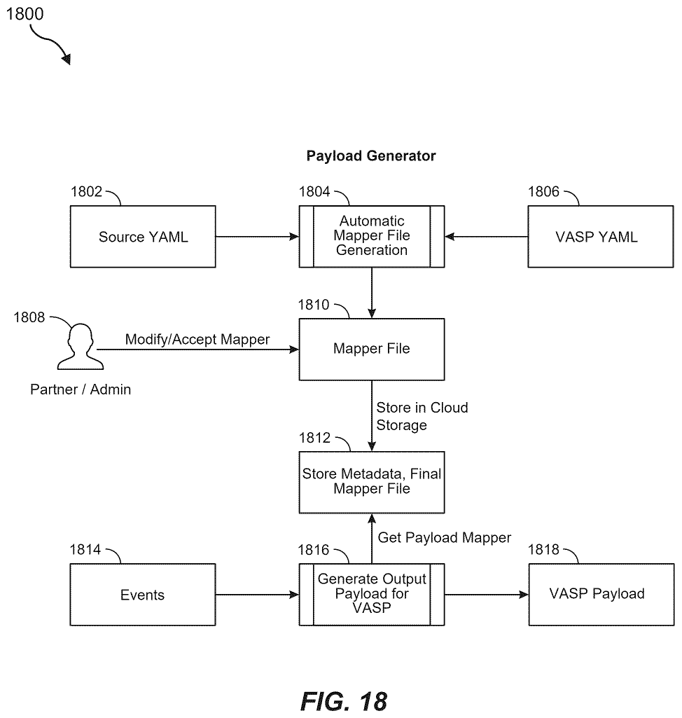

Regarding dynamic payload generator 214, retail wireless value-added service platform 202 can dynamically generate a payload, in terms of notifications from a mobile operator to a value-added service provider, based at least in part on a data serialization language specification file that is specific to the value-added service provider and that is generated based on preferences indicated by the value-added service provider. Details regarding dynamic payload generator 214 will be described in more detail below in connection with diagram 1800 of FIG. 18.

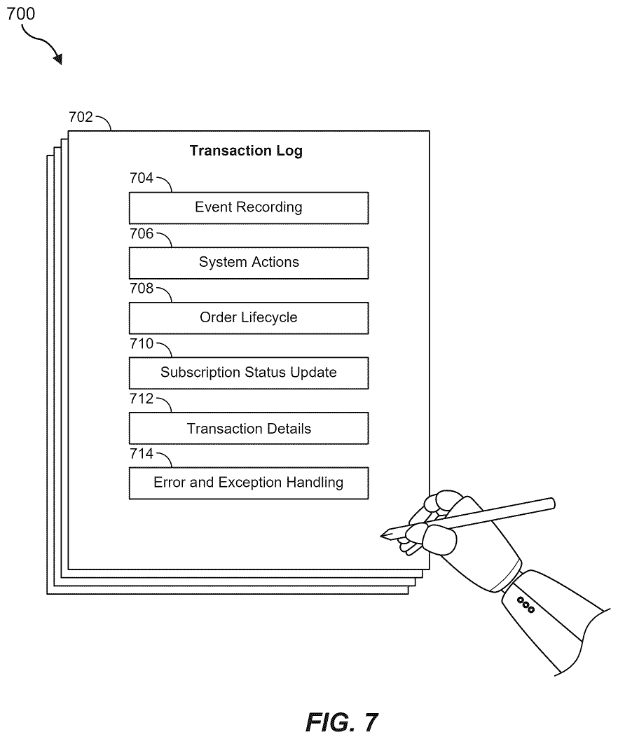

Regarding value-added service transaction log 216, retail wireless value-added service platform 202 may create a log of all details associated with transactions and/or communications involving a respective value-added service provider. These can include transactions or communications between the value-added service provider and the mobile operator in either direction. Additionally, or alternatively, this can also include transactions or communications between the value-added service provider and one or more subscribers in either direction. These can include any of the application programming interface calls and/or input operations that are described at length above in connection with diagram 200, for example. Further details regarding value-added service transaction log 216 will be described in more detail below in connection with diagram 700 of FIG. 7. Regarding fallout handling and automated reprocessing 218, retail wireless value-added service platform 202 may automatically attempt to reprocess one or more orders or transactions in response to detecting that the order has not successfully completed or processed by a specified time.

FIG. 2B shows a diagram 203 of a graphical user interface for a value-added service provider to use the application programming interface. Diagram 203 can include a file button 220, an edit button 222, a help button 224, a username prompt 226, a password prompt 228, an ok button 230, and a cancel button 232, as shown. More generally, the application programming interface may authenticate or validate subscribers and/or customers. In some illustrative examples, the application programming interface can perform one or more of these authentication procedures through a CAPTCHA challenge-response test. CAPTCHA, or Completely Automated Public Turing test to tell Computers and Humans Apart, can serve to distinguish between human users and automated bots or scripts on the Internet, aiming to prevent automated systems from abusing online services or websites by requiring users to perform tasks that are easy for humans but difficult for machines to solve. There are various types of CAPTCHAs, each designed with different challenges to test human interaction. Text-based CAPTCHAs can display distorted text characters that users must enter correctly into a text box, often warped, obfuscated, or overlaid with noise to hinder recognition by automated systems. Image-based CAPTCHAs can present users with images containing objects, shapes, or patterns that they must identify or select, such as cars or street signs, to prove they are human. Audio CAPTCHAs can play distorted or obscured sounds, words, or numbers that users must listen to and transcribe into a text box, accommodating users with visual impairments or difficulty with visual challenges. Checkbox CAPTCHAs can require users to perform simple tasks, like checking a box next to the statement “I am not a robot” or selecting images matching a specific criterion, such as “Select all images containing traffic lights.” Interactive CAPTCHAs can engage users in actions like dragging and dropping objects, solving puzzles, or completing mini-games. Behavioral CAPTCHAs can analyze user behavior, such as mouse movements or keystrokes, to determine if they exhibit human-like interactions with the website or service, aiming to identify and prevent automated bot attacks based on behavioral anomalies.

More generally, a mobile operator application programming interface can authenticate a value-added service provider worker, agent, or software component trying to log in through various methods to ensure secure access and prevent unauthorized usage. One method can include passwords, where users are required to enter a combination of characters known only to them to verify their identity. Additionally, Two-Factor Authentication (2FA) can add an extra layer of security by requiring users to provide a second form of authentication, typically through a code sent to their mobile device via SMS, email, or generated by an authenticator app. Biometric authentication methods, such as fingerprint scanning or facial recognition, can provide another level of security by verifying the user's unique physical characteristics. Similarly, hardware tokens or smart cards can be used for authentication, where users must possess a physical device to access the application programming interface. OAuth and OpenID Connect are standards for delegated authentication, allowing users to log in using their existing credentials from trusted identity providers, such as Google or Facebook, without sharing their password with the mobile operator. Single Sign-On (SSO) solutions can enable users to access multiple services or applications with a single set of credentials, streamlining the authentication process and enhancing user experience. Furthermore, Risk-Based Authentication (RBA) can evaluate various factors, such as device fingerprinting, geolocation, and user behavior, to assess the risk associated with a login attempt and apply appropriate security measures accordingly.

FIG. 2C shows a diagram 205 of the graphical user interface enabling new value-added service provider onboarding. As shown, diagram 205 can include new value-added service provider onboarding 234, which can further include update value-added service provider profile 235, subscription management 236, and/or product management 237. New value-added service provider onboarding 234 corresponds to a simplified example, for illustrative purposes, of a graphical user interface providing access to the value-added service provider in order to utilize different features of the corresponding application programming interface, as further discussed above. Update value-added service provider profile 235 may allow the provider to edit or update any one or more fields of the corresponding profile that the mobile operator maintains for the value-added service provider, including any one or more of the various details that the provider can input to the application programming interface as part of the onboarding procedure, as described at length above regarding partner onboarding and profile management 204. Subscription management 236 may allow the provider to manage one or more subscriptions for corresponding subscribers, including any one or more of the various management features described at length above regarding subscription management 210. Product management 237 may allow the provider to manage any details regarding the various products and/or services that the provider provides through the mobile operator, including any one or more of the various details and/or features described above in connection with partner product management 206.

FIG. 2D shows a diagram 207 of the graphical user interface enabling a value-added service provider to perform actions with respect to various secure Wi-Fi products or services. Accordingly, diagram 207 shows one example of how the graphical user interface may be presented in response to the provider selecting product management 237 in FIG. 2C. Diagram 207 further shows a secure Wi-Fi product 250, a secure Wi-Fi product 252, and a secure Wi-Fi product 254. An indicator 244, and indicator 245, and an indicator 246 may highlight to the viewer how these different products may be associated with substantially different price points. An indicator 248 shows that the respective products help to protect consumers or subscribers from malware or threat actors. An indicator 256, and indicator 258, and an indicator 260 are simplified example for illustrative purposes of different kinds of Wi-Fi routers or access points. Diagram 207 also further illustrates three instances of an activate product button 238, three instances of a deactivate product button 240, and three instances of an update product button 242, as shown.

As mentioned above, a value-added service provider can offer secure Wi-Fi to customers of a mobile operator through various methods such as deploying Virtual Private Network (VPN) services to encrypt internet traffic, implementing Wi-Fi encryption protocols like WPA2, and utilizing advanced authentication mechanisms like WPA3. Additionally, network security solutions such as Intrusion Detection Systems (IDS) and Intrusion Prevention Systems (IPS) can detect and mitigate security threats in real-time, while Secure Socket Layer (SSL) or Transport Layer Security (TLS) protocols encrypt data transmitted over the internet. Wi-Fi management platforms can provide network administrators with tools to monitor and control access, enforce security policies, and track user activity, ensuring compliance with regulatory requirements and enhancing overall network security and user privacy.

Diagram 207 corresponds to a simplified example that enables the value-added service provider to perform product management with respect to one type of product, which in this case corresponds to secure Wi-Fi. Diagram 207 illustrates how the provider is enabled to activate the product in terms of live offerings from the mobile operator, deactivate the product, and/or update the product. These examples are merely illustrative. Additionally, or alternatively, in other examples the application programming interface may enable the value-added service provider to perform any one or more other suitable actions with respect to product management for products and/or services that the value-added service provider maintains or offers with respect to the mobile operator. These actions can include any one or more of the actions that are further described above in terms of onboarding the value-added service provider with the application programming interface.

FIG. 2E shows a diagram 209 of the graphical user interface enabling the value-added service provider to perform actions with respect to various international calling plan products or services. Accordingly, diagram 207 shows another example of how the graphical user interface may be presented in response to the provider selecting product management 237 in FIG. 2C. Diagram 209 substantially parallels diagram 207, except that diagram 209 focuses upon international calling plans rather than secure Wi-Fi. According to, diagram 209 further includes an international calling plan 262, an international calling plan 264, and an international calling plan 266, as shown. Consistent with the earlier discussion above, a value-added service provider can offer an international calling plan to customers of a mobile operator by partnering with telecommunications carriers worldwide to provide access to their global networks. Through this partnership, customers can access competitive international calling rates and expanded coverage to connect with friends, family, and colleagues around the world. The service provider can integrate the international calling plan into the mobile operator's existing service offerings, allowing customers to easily subscribe to the plan through their mobile device or online account portal. Additionally, the service provider can offer flexible pricing options, such as pay-as-you-go or monthly subscription plans, to suit different usage patterns and budgetary preferences. To enhance user experience and convenience, the service provider can also develop a mobile application or web interface that enables customers to manage their international calling plan, track usage, and view billing details in real-time. The examples of diagram 207 and 209 are merely illustrative. In other examples, the graphical user interface can be updated to enable any suitable value-added service to manage any one or more of various types of value-added services.

FIG. 2F shows a diagram 211 of the graphical user interface enabling the value-added service provider to perform actions with respect to different subscribers. Accordingly, the graphical user interface may be presented in response to the provider selecting subscription management 236 in FIG. 2C. Diagram 211 shows rows 290-298 and columns 276-288. Rows 290-298 may correspond to respective customers who have subscribed to one or more value-added services. Column 276 shows respective hashes and/or anonymized identifiers for these respective customers. Column 280 shows respective instances of a button for adding a particular product to the corresponding customer. Similarly, column 282 shows respective instances of a button for removing the particular product from the corresponding customer's account. Additionally, or alternatively, diagram 211 also includes a column 284, column 286, and a column 288, which further show various instances of additional buttons for generic actions that the provider can take in respect to a corresponding subscriber. These various actions may include modifying any one or more attributes associated with the subscription that the subscriber has with the value-added service provider.

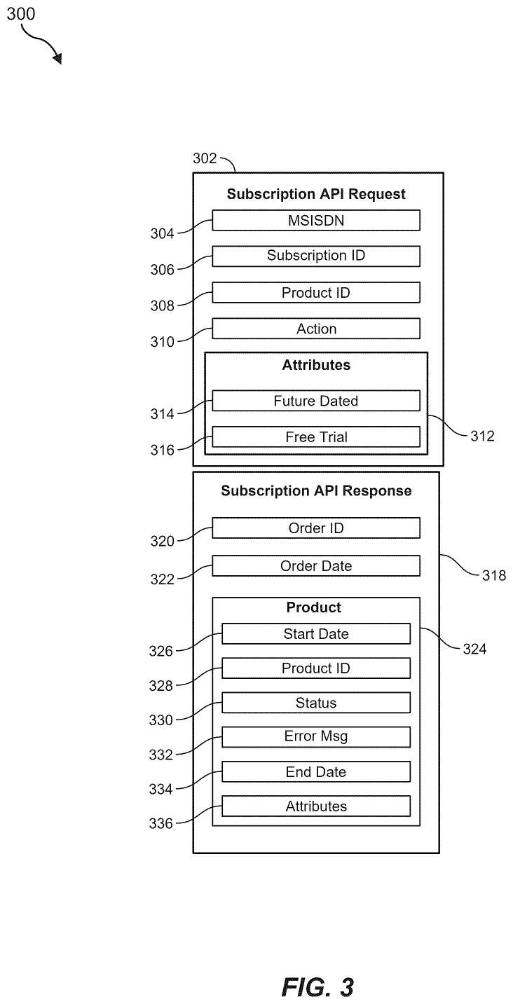

FIG. 3 shows a diagram 300 of a subscription application programming interface. Diagram 300 shows a subscription application programming interface request 302, which can further include a mobile station international subscriber directory number 304, a subscription identifier 306, a product identifier 308, an action 310, and/or attributes 312, which can further include a future dated field 314 and/or a free trial field 316. In response, diagram 300 further shows that the mobile operator may issue a subscription application programming interface response 318, which can include an order identifier 320, an order date 322, and/or a product 324. Product 324 can further include a start date 326, a product identifier 328, a status 330, an error message 332, and end date 334, and/or one or more generic attributes 336, as shown.

In the context of an application programming interface provided by a mobile operator to a value-added service provider, a subscription application programming interface request can include one or more of these parameters to facilitate efficient subscription management and service delivery. The mobile station international subscriber directory number can serve as a unique identifier for the subscriber's mobile device, allowing the service provider to associate the subscription request with the correct account. The subscription ID and product ID can specify the specific subscription and product being requested or managed, providing clarity and precision in the subscription process. The action parameter can indicate the desired action to be performed on the subscription, whether it's subscribing to a new service, concluding an existing subscription, or querying the status of a subscription. Additionally, attributes such as “future dated” and “free trial” can provide additional context and instructions for the subscription request, allowing the service provider to schedule future subscription activations or offer trial periods to users.

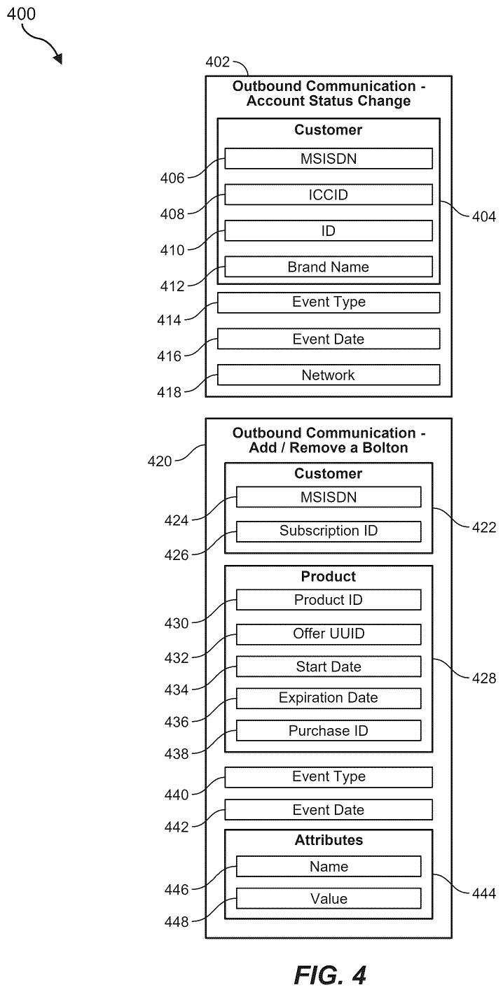

FIG. 4 shows a diagram 400 of an outbound communication account status change application programming interface as well as an outbound communication application programming interface for adding or removing a bolton. As shown outbound communication account status change 402 may identify a customer 404, which can further identify associated values including a mobile station international subscriber directory number 406, am integrated circuit card identification 408, a customer identifier 410, and a brand-name 412. Outbound communication account status change 402 may further include an event type 414, an event date 416, and a network 418.

In the context of an application programming interface provided by a mobile operator to a value-added service provider, outbound communication reporting an account status change can include various parameters to ensure accurate and efficient communication between systems. The mobile station international subscriber directory number can serve as the primary identifier for the subscriber's mobile device, enabling the service provider to uniquely identify the affected account. The integrated circuit card identifier can provide additional information about the SIM card associated with the device, aiding in device identification and troubleshooting. The customer identifier can act as a unique reference code assigned to the account or transaction, facilitating traceability and auditability of the reported event. The brand parameter can specify the mobile operator's brand or network associated with the account, providing context for the event. The event type can categorize the nature of the account status change, such as activation, suspension, or termination, enabling the service provider to process the event accordingly. Other events potentially triggering outbound communication can include changing the mobile station international subscriber directory number, restoring the subscription, adding an offer to the subscription account, removing the offer from the subscription account, swapping one device for a second device, swapping a subscriber identity module for a different subscriber identity module, performing a port-in procedure, and/or performing a port-out procedure. The event date timestamp can indicate the exact date and time when the account status change occurred, ensuring timeliness and accuracy in reporting. Finally, the network identifier can specify the network or carrier associated with the account, allowing the service provider to route and manage communications effectively within the mobile operator's network infrastructure. The network identifier can be particularly useful in the context of a mobile operator that interfaces with multiple distinct mobile networks, such as its own mobile network as a mobile network operator and/or one or more other networks as a mobile virtual network operator.

Diagram 400 also illustrates outbound communication add/remove a bolton 420, which further specifies a customer 422, a product 428, an event type 440, an event date 442, and/or attributes 444, as shown. Customer 422 can further specify a mobile station international subscriber directory number 424 and a subscription identifier 426. Product 428 can further specify a product identifier 430, an offer universally unique identifier 432, a start date 434, and expiration date 436, and a purchase identifier 438. Attributes 444 may further specify a name 446 and/or a value 448.

The offer universally unique identifier can provide a unique reference to the specific offer being modified, aiding in tracking and validation processes. Including the start date and expiration date can enable the service provider to manage the timing of the bolton's activation and deactivation accurately. The purchase identifier can serve as a reference for the transaction, facilitating audit trails and customer support inquiries. The event type of activation can indicate the nature of the change, whether a bolton is being added or removed. Attributes such as the offer type with a value of “bolton” can provide further context, clarifying that the change pertains to a bolton service.

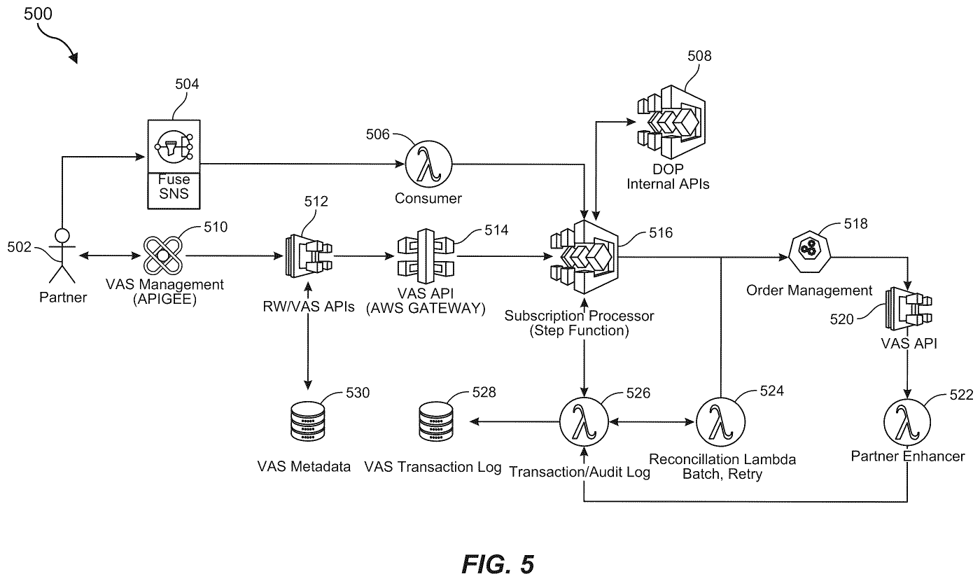

FIG. 5 shows a diagram 500 of an inbound communication management architecture. In general, a partner 502 can communicate with a filesystem in userspace (FUSE) 504 interfacing with a cloud storage provider, such as Amazon S3, through a push notification service such as Amazon Simple Notification Service (SNS). This enables the partner to communicate further with a consumer 506. Subscription processor 516 may process subscription requests for corresponding consumers, as shown. The mobile operator may provide a digital operator platform that centralizes and coordinates communications and operations between the mobile operator and retail wireless components, for example. The digital operator platform may provide internal application programming interfaces 508. Partner 502 may also further communicate with a value-added service management component 510, a retail wireless/value-added service application programming interface 512, as well as a value-added service application programming interface for a cloud storage gateway 514. Retail wireless/value-added service application programming interface 512 may manage value-added service metadata 530. Subscription processor 516 may provide a transaction/audit log 526, which may be further stored within a value-added service transaction log database 528. Subscription processor 516 may also utilize a reconciliation lambda batch 524. Subscription processor 516 may also communicate with order management 518, which can further interface with a value-added service application programming interface 520. Value-added service application programming interface 520 may further connect to a partner enhancer 522, as shown. Generally speaking, the various components and interactions shown within diagram 500 may be interpreted within the larger context of the application programming interface outlined above in connection with method 100, for example.

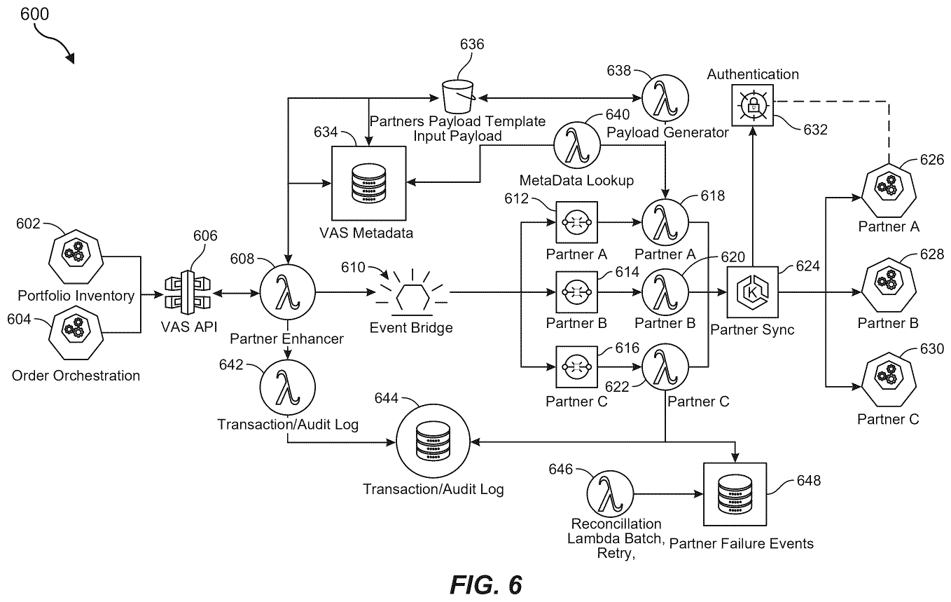

FIG. 6 shows a diagram 600 of an outbound communication management architecture. As shown, the outbound communication management architecture may include a portfolio inventory 602 and an order orchestration 604 interfacing with a value-added service application programming interface 606, which can further interface with a partner enhancer 608 and a transaction/audit log 642. In general, diagram 600 may use parallel names for parallel components from diagram 500, even if the reference numerals have been updated in the context of diagram 600. Partner enhancer 608 may further interface with value-added service metadata 634, partners payload template input payload 636 and payload generator 638, as discussed in more detail below. Metadata lookup 640 may lookup data from value-added service metadata 634 and supply the data to a corresponding partner, as shown. Partner enhancer 608 may also communicate through an event bridge 610 to a partner 612, a partner 614, and a partner 616, which may include corresponding partner lambda component 618, partner lambda component 620, and partner lambda component 622, which can be synchronized according to a partner synchronization Kubernetes platform 624. Transaction/audit log 642 may further interface with a transaction/audit log database 644 and a partner failure events database 648. Reconciliation lambda batch 646 may manage partner failure events database 648. On the other side of diagram 600, a partner 626, a partner 628, and a partner 630 may authenticate through an authentication component 632 with partner synchronization Kubernetes platform 624. Similar to diagram 500, the various components and interactions shown within diagram 600 may be interpreted within the larger context of the application programming interface outlined above in connection with method 100, for example.

FIG. 7 shows a diagram 700 of a transaction log. Consistent with the discussion above, transaction log 702 may include event recording 704, system actions 706, order lifecycle 708, subscription status update 710, transaction details 712, and/or error and exception handling 714. Event recording 704 of the transaction log can play a role in tracking and documenting all interactions and changes related to the service, ensuring transparency, accountability, and traceability. Relevant events that the application programming interface might record include subscription activations, deactivations, renewals, modifications, bolton additions or removals, and account status changes such as suspensions or reactivations. Each event provides insight into the lifecycle of a service from initiation to termination. Event recording 704 can capture several types of data and metadata for each event: the event type specifies the nature of the event, such as activation, deactivation, renewal, bolton addition, bolton removal, or account status change; the timestamp records the exact date and time when the event occurred, ensuring a precise timeline of activities; the mobile station international subscriber directory number uniquely identifies the subscriber involved in the event; the subscription ID links the event to the specific service; the product ID clarifies which service is being referenced; the offer UUID ensures precise tracking of the offer or bolton being modified; start and expiration dates indicate the validity period of the service or bolton; the purchase ID helps in auditing and customer support processes; account status records changes in the account status, providing a complete view of the account's state; event metadata includes additional context-specific information such as the reason for a status change, the user initiating the change, and any relevant notes or comments; the network identifier specifies the network or carrier associated with the event; action taken describes the action performed, such as subscribing, unsubscribing, adding a bolton, etc.; and offer type and value detail type of the offer involved, enhancing clarity on the event's purpose.

System actions 706 can document and track all automated actions and system-level events that occur as part of the service interaction, ensuring a comprehensive audit trail of system activities for better management, troubleshooting, and compliance monitoring. The relevant events that the application programming interface might record could include system-initiated subscription renewals, automated billing processes, service updates, error notifications, and system maintenance activities. System actions 706 would capture various items of data and metadata for each event: in addition to all of the items listed above for diagram 700, the system process ID aids in tracking and troubleshooting; the status code indicates the result of the system action, such as success, failure, or pending; error code and message capture specific errors, facilitating diagnosis and resolution; the initiator specifies whether the action was system-initiated or triggered by a user, adding context; action details provide additional information about the action performed; affected services list any impacted services, ensuring visibility into potential disruptions; previous state and new state record the state of the system before and after the action, providing a clear before-and-after comparison; and metadata includes contextual information such as the reason for the action, user comments, or related system logs.

Order lifecycle 708 can play a role in tracking and documenting the entire process of a customer's order from initiation to completion. This component can ensure that every step of the order process is recorded, providing a comprehensive audit trail that facilitates order management, troubleshooting, and customer service. Order lifecycle 708 can capture a variety of relevant items of data and metadata for each order: in addition to all of the items listed above for diagram 700, these can include order status indicating the order's progression, such as pending, processing, completed, canceled, or failed; order details including quantity, price, and customization options; payment method details; billing information for payment processing; shipping information for physical goods; fulfillment status tracking delivery or activation; transaction ID for the financial transaction; a detailed event log of all actions and status changes; error codes and messages for troubleshooting issues; customer communications related to the order; and metadata providing contextual information such as order source, promotional codes applied, and internal notes.

Subscription status update 710 can play a role in tracking and documenting changes in the status of customer subscriptions, ensuring every update is accurately recorded for a comprehensive audit trail that facilitates subscription management, troubleshooting, and customer support. Subscription status update 710 can capture a variety of relevant items of data and metadata for each status change: in addition to the items listed above for diagram 700, these items can include an old status indicating the subscription's status before the update; a new status showing the status after the update; a reason code explaining why the update occurred, such as payment failure or customer request; an initiator specifying whether the update was system-initiated or user-triggered; validity period recording the start and end dates affected by the update; attributes detailing promotional conditions or trial periods; error codes and messages capturing issues during the update for troubleshooting; and metadata including additional contextual information like payment method update, operating network, and relevant internal notes.

Transaction details 712 can comprehensively document all aspects of transactions between the operator and the service provider, ensuring transparency, accountability, and traceability by recording detailed information about each transaction. This component can facilitate effective management, auditing, and troubleshooting by encompassing various types of relevant data and metadata for each transaction, which can include all of those listed above for diagram 700 as well as the transaction amount indicating monetary value, payment method detailing the method of payment, payment status reflecting payment status, billing information, transaction status, error codes and messages for troubleshooting, the initiator indicating which party initiated a transaction, and metadata providing additional contextual information.

Error and exception handling 714 can play a role in managing and resolving errors or exceptions that occur during transactions or interactions, ensuring prompt identification, logging, and resolution of issues to minimize disruptions to service and ensure smooth operation. This component can encompass various types of relevant data and metadata for each error or exception, which can include those listed above for diagram 700 as well as a unique error code for categorization and troubleshooting, a descriptive error message providing insight into the nature of the issue, a timestamp for temporal analysis, an error type classifying the nature of the issue, a severity level indicating its impact, an error source identifying its origin, an error resolution status tracking its resolution progress, error handling steps documenting mitigation efforts, affected services listing impacted functionalities, and metadata offering contextual information.

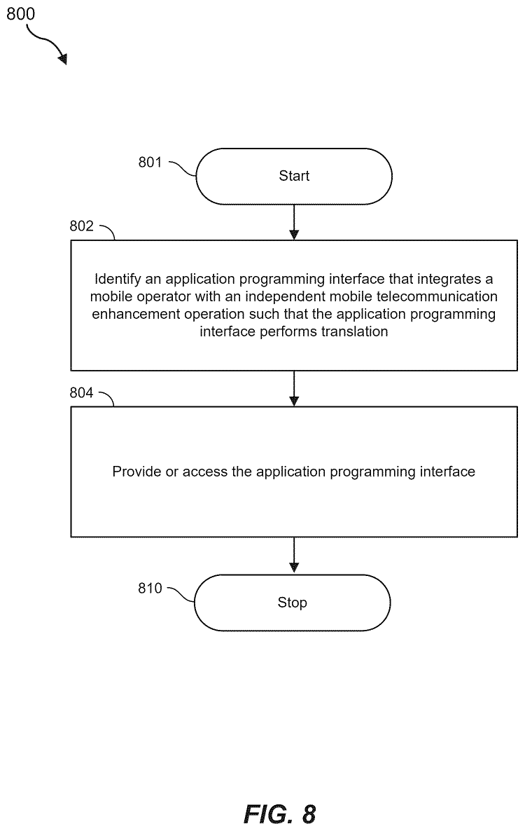

FIG. 8 shows a flow diagram for another method 800 relating to an independent mobile telecommunication enhancement operation integration platform. At step 801 method 800 may start or begin. At step 802, method 800 may include identifying, by a mobile operator or an independent mobile telecommunication enhancement operation that provides a mobile telecommunication enhancement for clients of the mobile operator, an application programming interface that integrates the mobile operator with the independent mobile telecommunication enhancement operation such that the application programming interface translates between data structures for fields that record mobile service operation details in a format that the mobile operator uses internally and second data structures for corresponding fields that record corresponding mobile service operation details in a distinct format that the independent mobile telecommunication enhancement operation uses internally. At step 804, method 800 may include providing or accessing, by the mobile operator or the independent mobile telecommunication enhancement operation that provides the mobile telecommunication enhancement for clients of the mobile operator, the application programming interface that integrates the mobile operator with the independent mobile telecommunication enhancement operation such that the application programming interface translates between the first data structures for fields that record mobile service operation details in the format that the mobile operator uses internally and the second data structures for corresponding fields that record corresponding mobile service operation details in the distinct format that the independent mobile telecommunication enhancement operation uses internally. At step 810, method 800 may stop or conclude.

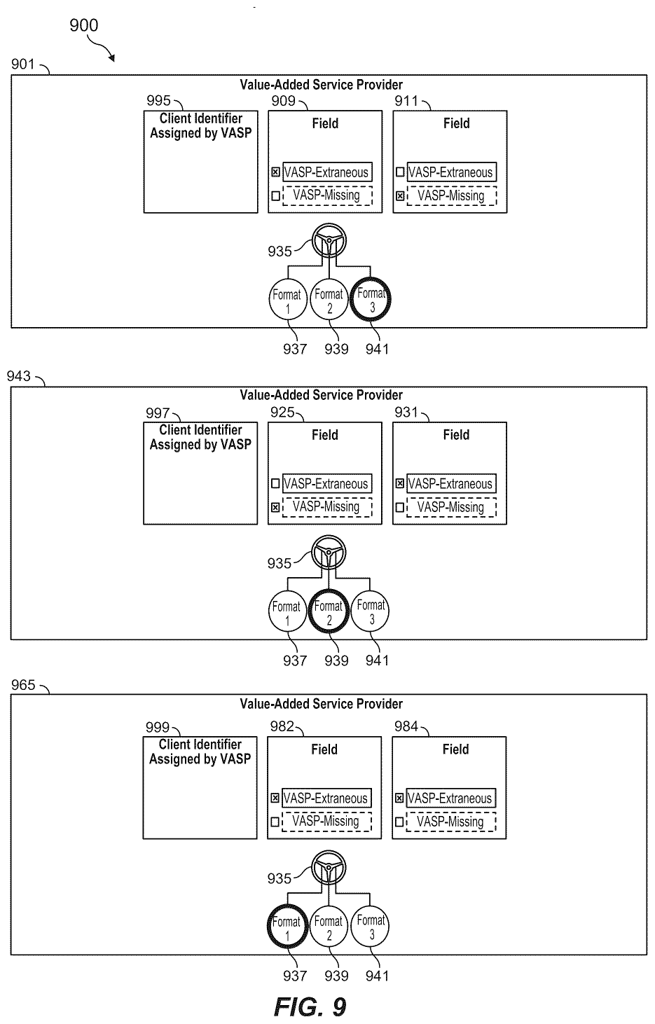

FIG. 9 shows a diagram 900 indicating how mobile service operation details may be stored in different formats for different value-added service providers. In particular, diagram 900 includes 901, a sub-diagram 943, and a sub-diagram 965. Each one of these respective sub-diagrams corresponds to a different value-added service provider that may interface with the mobile operator using the application programming interface, as further discussed above. Diagram 900 helps to explain how, in various examples, the application programming interface may optionally provide a layer of abstraction such that the mobile operator uses its own standardized format for recording mobile service operation details. Additionally, or alternatively, the application programming interface may also effectively obscure one or more items of information or values that are specific to a particular value-added service provider. Furthermore, the application programming interface may optionally substitute the particular value that a value-added service provider assigns to a particular client, subscriber, device, or other object with its own value. Creating the layer of abstraction, obscuring one or more items of information assigned by the value-added service provider, and/or substituting one or more of its own values may help to prevent a subversive lock on the value-added service provider such that a barrier or obstacle is created when attempting to extract the mobile operator from the particular value-added service provider, as in a scenario where the mobile operator seeks to substitute one value-added service provider with another value-added service provider. By way of illustrative example, in such a scenario, using the particular format and/or values that a first value-added service provider assigns to a subscriber and/or one or more of its associated objects or devices can create friction when attempting to switch to a second and distinct value-added service provider.

In view of the above, the application programming interface can optionally and effectively render some layer or portion of the mobile operator to be agnostic between value-added service providers. This layer of the mobile operator may see data or messages incoming from various value-added service providers in a standardized format such that the layer of the mobile operator has effectively no visibility into which particular value-added service provider issued the data or messages.

More generally, the mobile operator and each one of the various respective value-added service providers that provide value-added services to clients of the mobile operator can each rely upon their own internal databases that store corresponding items of data in different formats, data structures, programming languages, levels of precision, variable types, etc. The application programming interface provided by a mobile operator to a value-added service provider can serve as a conduit for facilitating communication and data exchange between their respective systems. This interface can operate with a multifaceted approach, adeptly translating between the diverse formats utilized by the mobile operator and the various providers to store identical data, thereby ensuring compatibility and interoperability across disparate platforms. One scenario illustrating the application programming interface's functionality can involve the mobile operator storing numerical values as strings, while certain providers opt for numeric representations with varying precision levels. In such cases, the application programming interface dynamically adjusts the format, meticulously converting strings into precise numeric values, thereby ensuring accurate interpretation and transmission of data across systems. Additionally, differences in data organization present another challenge, with the mobile operator employing one data structure and a provider utilizing an entirely distinct schema. In this example, the application programming interface can act as an intelligent mediator, harmonizing the disparate structures to enable integration and data exchange between systems. Furthermore, variations in database protocols, programming languages, and/or variable types can indicate the helpfulness of comprehensive translation mechanisms within the application programming interface. For instance, while the mobile operator's system may utilize SQL for database management and Java for application development, a provider might leverage NoSQL databases and Python for programming. In such scenarios, the application programming interface can translate data between SQL and NoSQL formats, while seamlessly bridging the gap between Java and Python environments to ensure smooth interoperability. Moreover, the application programming interface can navigate discrepancies in data encoding, encryption methods, and character sets to facilitate secure and reliable data transmission between the mobile operator and the service provider.

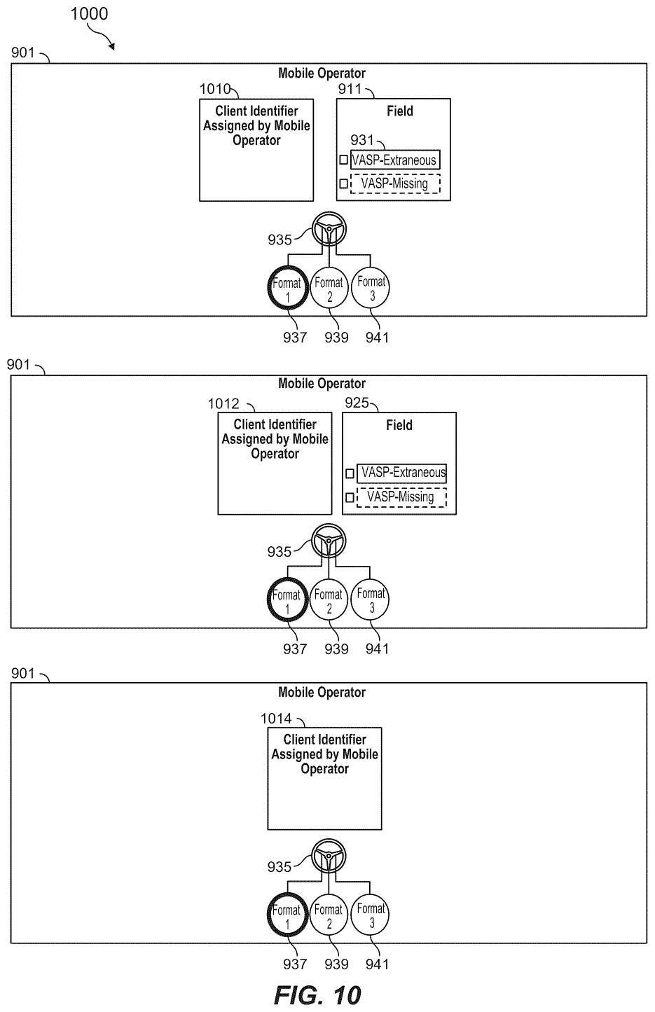

Returning to diagram 900, each one of sub-diagram 901, sub-diagram 943, and sub-diagram 965 may include a client identifier assigned by the value-added service provider 995, a client identifier assigned by the value-added service provider 997, a client identifier assigned by the value-added service provider 999, a field 909, and a field 911. The client identifier assigned by the value-added service provider may correspond to a particular identifier that the client has assigned to a particular client to uniquely or otherwise identify the client. As outlined above, in some examples the application programming interface provided by the mobile operator can optionally translate and/or obfuscate the client identifier into a client identifier assigned by the mobile operator, as discussed further below in connection with diagram 1000 of FIG. 10. Field 909, field 911, field 925, field 931, field 982, and field 984 are merely generic fields, for illustrative purposes, showing that the various value-added service providers may store fields of data in different formats, and may also store data that is extraneous and/or fail to store data that is required or requested from the perspective of the mobile operator. Within diagram 900, data that is extraneous from the perspective of the mobile operator and, therefore, can be omitted from the standardized format in which the mobile operator stores the corresponding data can be indicated by a checkbox next to the “extraneous” indicator, as shown. Similarly, within diagram 900, data that is missing from the perspective of the mobile operator and, therefore, should be inserted, substituted, and/or enhanced within the standardized format in which the mobile operator stores the corresponding data can be indicated by a checkmark next to the “missing” indicator, as shown.

Diagram 900 also includes, within sub-diagram 901, sub-diagram 943, and sub-diagram 965, a figurative wheel 935 that can toggle between a format 937, a format 939, and a format 941. Diagram 900 illustrates how the data within diagram 901 is stored in format 941, the data within sub-diagram 943 is stored in format 939, and the data within diagram 965 is stored in format 937. Accordingly, diagram 900 thereby illustrates how the various different value-added service providers may store essentially the same data, or essentially the same types of data, within fundamentally different data formats. The usage of fundamentally different data formats thereby suggests the utility or benefit of the application programming interface providing a translation component that effectively translates between these data formats and, furthermore, can translate any of these various different formats into a single standardized format, as discussed further below in connection with diagram 1000 of FIG. 10.

FIG. 10 shows a diagram 1000 indicating how a mobile operator may standardize the mobile service operation details. Diagram 1000 substantially parallels diagram 900 except that, in diagram 1000, the corresponding data has been stored within the standardized format used by the mobile operator after translation through the translation component of the application programming interface, as further discussed above. Accordingly, the client identifier assigned by the value-added service provider in diagram 900 has been effectively replaced, within diagram 1000, by a corresponding client identifier assigned by mobile operator 1010, a client identifier assigned by mobile operator 1012, and a client identifier assigned by mobile operator 1014. Similarly, whereas diagram 900 indicated that field 911 and field 925 were missing within the databases and/or communications of the respective value-added service providers, diagram 1000 shows that these respective fields have been restored within the database of the mobile operator and the checkbox next to the missing indicator has been removed accordingly. Similarly, whereas diagram 900 indicated that field 909, field 931, field 982, and field 984 were all extraneous, diagram 1000 shows that these respective fields have been completely omitted.

Additionally, diagram 1000 also shows that, within mobile operator 901, the various mobile service operation details have been stored in the same or synchronized format, which in the illustrative example of diagram 1000 corresponds to format 937. Accordingly, both mobile operator 901 and value-added service provider 965 may use format 937 originally, whereas the transition component of the application programming interface may effectively translate mobile service operation details from format 939 or format 941 into format 937 such that all of the mobile service operation details incoming from various value-added service providers are stored within a standardized format. Additionally, or alternatively, in other examples the mobile operator may originally use a distinct format that is distinct from all of the formats used by the various value-added service providers to which the mobile operator has partnered.

More generally, disparities in data formats and completeness may arise, posing challenges to seamless integration and standardized data management. One common challenge involves extraneous data within providers' databases that does not align with the mobile operator's standardized format. In such cases, the application programming interface may employ data filtering or transformation techniques to selectively extract relevant information while discarding extraneous data, ensuring that only pertinent data is transmitted and stored within the mobile operator's systems. Additionally, discrepancies may emerge where certain items of data are missing entirely from the providers' databases, hindering comprehensive data synchronization. Here, the application programming interface can leverage various strategies to insert or enhance missing data, even without direct input from the providers. For instance, through data inference algorithms, the application programming interface can analyze existing data sets and extrapolate missing information based on patterns, trends, or correlations present in the available data. Furthermore, by incorporating external data sources or application programming interfaces, the application programming interface can supplement missing data points with relevant information obtained from trusted sources or third-party data providers. Moreover, the application programming interface may employ data enrichment techniques, such as data augmentation or interpolation, to enhance the completeness and accuracy of existing data sets, thereby ensuring consistency and integrity across the mobile operator's data ecosystem. By adeptly addressing these challenges and employing innovative data management strategies, the application programming interface can facilitate seamless integration and harmonization of data from diverse providers, ultimately enabling the mobile operator to maintain standardized data formats and enhance the overall quality and reliability of its data infrastructure.

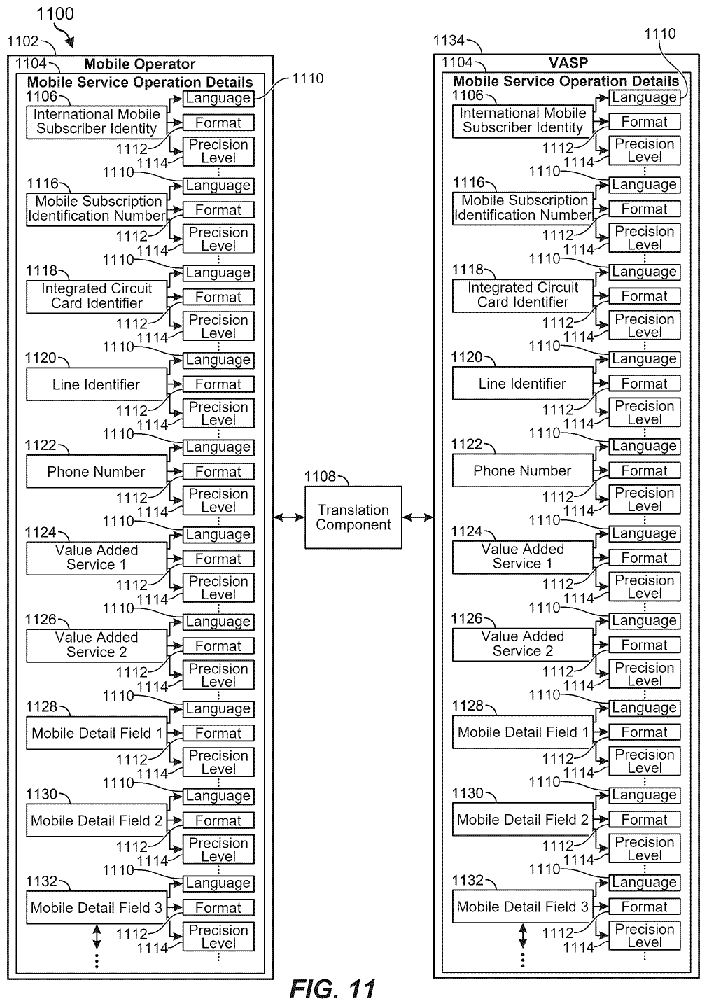

FIG. 11 shows a diagram 1100 further indicating how mobile service operation details may be stored in different formats for different value-added service providers. In particular, diagram 1100 shows a mobile operator 1102 and a value-added service provider 1134, which correspond in diagram 1100 to their respective internal databases. Diagram 1100 further shows that mobile operator 1102 may store mobile service operation details 1104 and, similarly, value-added service provider 1134 may store a parallel instance of mobile service operation details 1104. Nevertheless, as discussed at length above, mobile operator 1102 and value-added service provider 1134 may store mobile service operation details 1104 in a variety of different formats.

Diagram 1100 also further shows that mobile service operation details may include an international mobile subscriber identity 1106, a mobile subscription identification number 1116, an integrated circuit card identifier 1118, a line identifier 1120, a phone number 1122, a value-added service 1124, a value-added service 1126, a generic mobile detail field 1128, a generic mobile detail field 1130, and a generic mobile detail field 1132. Diagram 1100 further illustrates how all of these fields of data may be stored in both mobile service operation details 1104 at mobile operator 1102 and mobile service operation details 1104 at value-added service provider 1134. Moreover, diagram 1100 also further indicates how each one of the various items of information that were listed above and shown within mobile service operation details 1104 may be stored in a corresponding language 1110, a format 1112, and/or a precision level 1114. As described at length above, the particular language, format, and/or precision level for each item of data may be different between different items of data and they may be different between mobile operator 1102 and value-added service provider 1134.

In view of the differences in terms of language, format, and/or precision level, etc., diagram 1100 also shows that the application programming interface provided by mobile operator 1102 may further include a translation component 1108. Translation component 1108 may effectively translate between the various instances of language 1110, format 1112, and precision level 1114 at mobile operator 1102 and corresponding language 1110, format 1112, and/or precision level 1114 at value-added service provider 1134. Transition component 1108 may operate according to any of the translation techniques that are outlined above in a manner that is consistent with those having skill in the art (e.g., switching variable types, synchronizing precision levels, synchronizing data structure organization, etc.).

As further discussed above, the application programming interface may optionally obfuscate an underlying client identifier that a particular value-added service provider assigned to a client such that at least one layer of the mobile operator only has visibility into a mapped identifier that the mobile operator has assigned to the same client without visibility into the client identifier that the particular value-added service provider assigned. Additionally, or alternatively, another layer or subcomponent of the mobile operator may maintain visibility into one or both of these items of information, and/or may maintain mapping information that enables the translation procedures. Maintaining a cache or historical record of the mapping information and/or the data in its original format from the value-added service provider can also benefit a troubleshooting component, as understood by those having skill in the art. Additionally, or alternatively, the translation component may also similarly translate and/or obfuscate other items of information, labels, and/or identifiers that the value-added service provider has assigned to a particular client in a manner that parallels how the translation component translated and/or obfuscated the client identifier. For example, another obfuscated item of data may include line identifier 1120. Moreover, although diagram 1100 focuses upon the various items of information that are shown as being included within mobile service operation details 1104, in other examples mobile service operation details 1104 may additionally or alternatively store any one or more of the various items of information that are discussed above in connection with diagram 700.

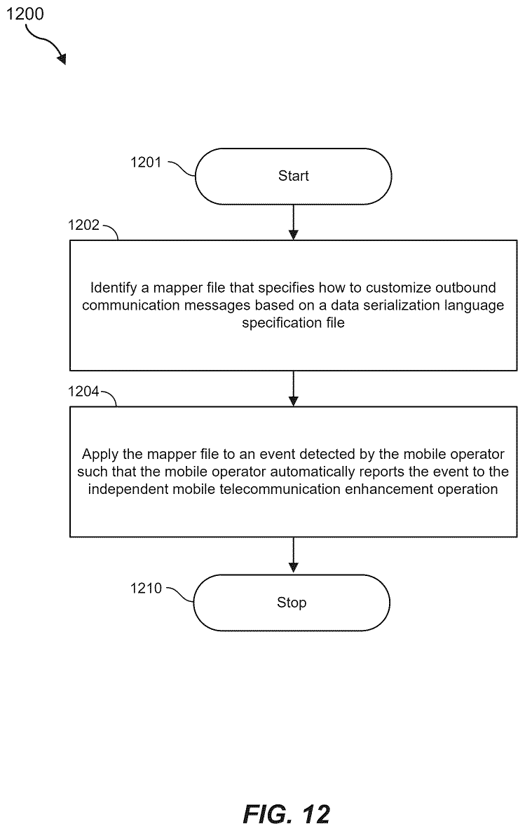

FIG. 12 shows a flow diagram 1200 for another method relating to an independent mobile telecommunication enhancement operation integration platform. At step 1201 method 1200 may start or begin. At step 1202, method 1200 may include identifying, by a mobile operator with clients for which an independent mobile telecommunication enhancement operation provides a mobile telecommunication enhancement, a mapper file that specifies how to customize outbound communication messages based on a data serialization language specification file for the independent mobile telecommunication enhancement operation that indicates outbound communication preferences of the independent mobile telecommunication enhancement operation that was generated based on input from the independent mobile telecommunication enhancement operation regarding outbound communication from the mobile operator to the independent mobile telecommunication enhancement operation. At step 1204, method 1200 may include applying, by the mobile operator with the clients for which the independent mobile telecommunication enhancement operation provides the mobile telecommunication enhancement, the mapper file to an event detected by the mobile operator such that the mobile operator automatically reports the event to the independent mobile telecommunication enhancement operation that provides the mobile telecommunication enhancement for the clients of the mobile operator in a manner that conforms to the outbound communication preferences of the independent mobile telecommunication enhancement operation as indicated by the data serialization language specification file for the independent mobile telecommunication enhancement operation regarding outbound communication from the mobile operator to the independent mobile telecommunication enhancement operation. At step 1210, method 1200 may stop or conclude.

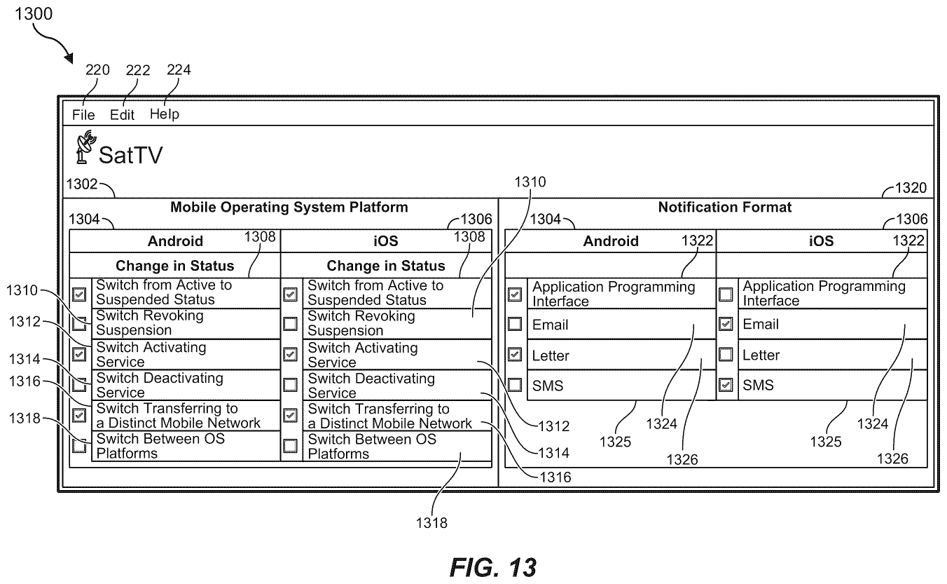

FIG. 13 shows a diagram 1300 of a graphical user interface indicating how value-added service providers may dynamically specify preferences for subscribing to event notifications regarding changes in status for a particular subscriber. Those having skill in the art will recognize that diagram 1300 is simplified for illustrative purposes and, in additional or alternative examples, more complex and/or comprehensive graphical user interfaces may be leveraged to implement method 1200 in a manner that provides more dynamic functionality and/or more variables across which to specify corresponding preferences, consistent with the discussion further below.

Diagram 1300 further includes a mobile operating system platform 1302 and a notification format 1320. The graphical user interface of diagram 1300 thereby enables a value-added service provider to dynamically specify preferences regarding outbound communication from the mobile operator to the value-added service provider across the variables that are graphically illustrated within this diagram. Accordingly, mobile operating system platform 1302 may further include Android 1304 and iOS 1306, thereby enabling the value-added service provider to dynamically or granularly distinguish between outbound communication preferences that apply to Android devices and outbound communication preferences that apply to iOS devices. Similarly, change in status 1308 helps facilitate the value-added service provider indicating different sets of preferences regarding different events or changes in status that are detected by the mobile operator with respect to a particular subscriber, device, and/or other associated event. Change in status 1308 can include a switch from active to suspended status 1308, a switch revoking suspension 1310, a switch activating service 1312, a switch deactivating service 1314, a switch transferring to a distinct mobile network 1316, and a switch between operating system platforms 1318, as shown. In the simplified example of the graphical user interface of diagram 1300, the value-added service provider may dynamically check one or more of these corresponding checkboxes to thereby indicate that the value-added service provider continues to seek, desire, or instruct outbound communications from the mobile operator to the value-added service provider notifying the value-added service provider regarding the corresponding events.

In addition to the above, diagram 1300 also includes a notification format 1320, which can further include an application programming interface 1322, email 1324, a letter 1326, and/or short message service message 1325. Those having skill in their will readily recognize that, in the simplified example of diagram 1300, these example of notification channels are merely illustrative and, in additional or alternative examples, any other suitable mechanism for notifying the value-added service provider regarding changes in the status of the corresponding subscriber may be utilized accordingly.

Although diagram 1300 focuses upon the example of variables that include the change in status of a subscriber, the mobile operating system platform, and/or the notification format, in other examples a wide variety of other variables may be utilized to notify the value-added service provider regarding any event detected at the mobile operator. In terms of events, a mobile operator's application programming interface can notify value-added service providers about a wide array of events detected at the mobile operator, enabling them to respond proactively and enhance their service offerings. Providers might prefer to be notified about network-related events, such as signal strength fluctuations, network outages, or congestion alerts, which can impact the quality of service and user experience. Usage-related events can also be relevant, including data usage thresholds being reached, unusual spikes in usage indicating potential fraud or abuse, and roaming activities that could affect billing and service availability. Device-related events, such as changes in device status (e.g., lost or stolen devices), firmware updates, or device compatibility issues, can help with maintaining security and functionality. Providers can benefit from notifications about user account activities, such as changes in billing information, payment confirmations, failed payment attempts, and account suspension due to non-payment or policy violations. Additionally, providers can benefit from being informed about user engagement metrics, such as app usage patterns, feature adoption rates, and feedback or support requests, which can guide service improvements and customer support strategies. Security events can be relevant, too, and can encompass unauthorized access attempts, login anomalies, and detected malware or security breaches, allowing providers to take immediate action to protect user data and maintain trust. Lastly, marketing and promotional events, such as the launch of new offers, discounts, or loyalty programs, can help providers tailor their communication and marketing efforts to drive engagement and revenue.

As another example of a variable that the application programming interface can allow the value-added service provider to dynamically specify notification purposes over, the value-added service partner can specify the details of the contents of the payloads that issue, respectively, in response to corresponding rules or scenarios. For example, the value-added service provider can specify that any one or more of the items discussed above for diagram 700 may be mapped to any particular rule and/or notification, as appropriate.

Rather than the notification channels shown in diagram 1300, the application programming interface can also optionally leverage one or more additional or alternative notification channels. One effective method can include push notifications sent directly to the providers' dedicated mobile or desktop applications, allowing instant alerts and actionable insights to be delivered in real-time. Another channel can include webhooks, where the mobile operator can set up HTTP callbacks to push event data directly to the providers' web services, triggering automated processes or workflows in response to specific events. Additionally, a secure online dashboard or portal can be established, providing providers with a centralized platform to access, monitor, and manage event notifications. This portal can offer real-time updates, detailed logs, and visual analytics, enhancing providers' ability to track and respond to events effectively. For more immediate and interactive communication, instant messaging platforms such as Slack or Microsoft Teams can be integrated, where dedicated channels can be created for different types of events, enabling real-time discussions and collaborative responses among the provider's team members. Furthermore, mobile operators can leverage in-app messaging within their own management applications, where contextual alerts and notifications can be embedded to inform providers of critical events as they navigate the app. Voice notifications through automated phone calls or voice assistants can also be employed for urgent alerts, ensuring that providers receive critical information even when they are away from their desks. Lastly, implementing real-time data streaming technologies, such as WebSockets or MQTT, can provide continuous event updates to the providers' systems, ensuring they remain informed about the latest developments without the need for constant polling or manual checks.

In addition to the operating system platforms shown in diagram 1300, the application programming interface can also distinguish between, or otherwise identify separately, other operating system platforms. For example, the application programming interface might recognize Windows Mobile, which is often used in enterprise environments and might involve notifications that are tailored to corporate security policies, device management updates, or specific enterprise application events. BlackBerry OS, known for its strong emphasis on security and email capabilities, is another example. The application programming interface might also dynamically support different notification preferences for devices that use Tizen, an open-source Linux-based operating system used in a range of devices from smartphones to smartwatches and IoT devices. Sailfish OS, which is another Linux-based platform, emphasizes privacy. Symbian, once a dominant OS in mobile devices, though less common today, might still be relevant for certain legacy systems, necessitating updates about application support, system upgrades, or security vulnerabilities. Additionally, the application programming interface could recognize to KaiOS, which is popular in feature phones and focuses on lightweight applications, necessitating notifications about data usage efficiency, lightweight app updates, or network connectivity issues. WebOS, known for its use in smart TVs and appliances, might require notifications related to cross-device interoperability, smart home integration updates, and multimedia content availability.

In addition to the checkboxes shown in diagram 1300, a graphical user interface for indicating notification preferences can employ a variety of other components and techniques to enhance usability and flexibility for value-added service providers. Dropdown menus can be utilized to allow users to select from a list of predefined notification types, ensuring clarity and precision in their choices. Radio buttons can serve a similar purpose for mutually exclusive options, enabling providers to select one preferred notification method among several alternatives. Toggle switches can offer a more intuitive way to enable or disable specific notifications, providing a clear visual indication of the current state. Additionally, sliders can be used for setting frequency or priority levels of notifications, allowing providers to fine-tune their preferences. Multi-select lists can enable users to choose multiple notification types simultaneously, which can be especially useful for complex configurations. Input fields with autocomplete functionality can help users quickly find and select specific notification types or settings, improving efficiency. Furthermore, modal dialogs or pop-up windows can present notification settings in a focused manner, guiding users through the process step-by-step. Contextual help icons or tooltips can provide additional information about each notification option, assisting users in making informed decisions. Advanced configurations can be handled through drag-and-drop interfaces, where users can organize and prioritize notifications by dragging items into desired order or categories. For more sophisticated needs, a preferences wizard can lead users through a series of steps to set up their notifications, ensuring that all necessary configurations are covered comprehensively. Additionally, implementing a search bar within the preferences interface can allow users to quickly locate and configure specific notification settings, enhancing overall usability.

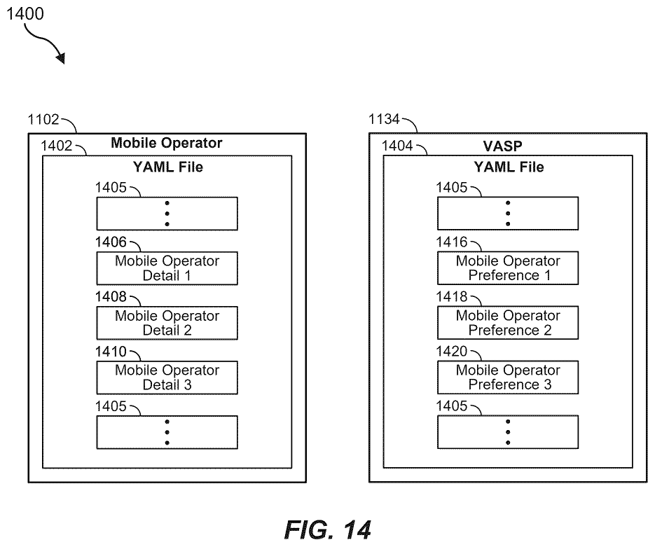

FIG. 14 shows a diagram 1400 indicating how a mobile operator and a corresponding value-added service provider may use two different data serialization language specification files, respectively. In particular, diagram 1400 shows that mobile operator 1102 may use a YAML file 1402 and value-added service provider 1134 may use a YAML file 1402. Although the YAML format is used for the purposes of illustration in diagram 1400, in additional or alternative examples any suitable data serialization language may be used. More generally, data serialization languages can play a role in data interchange by converting complex data structures into formats that can be easily stored, transmitted, and reconstructed later, ensuring consistency and accuracy regardless of the underlying system architecture. Their primary purpose is to facilitate smooth communication between disparate systems and applications, particularly in distributed computing environments where data needs to be shared across networked systems. These languages define the structure, types, and constraints of data, ensuring adherence to a specified format and maintaining data integrity and consistency during exchanges. Additionally, they often include mechanisms for versioning and extending data schemas, which facilitates evolving data structures over time without breaking compatibility with existing systems. By providing a common framework for data representation, serialization languages enhance interoperability between different programming languages, platforms, and technologies, making it easier to build scalable and maintainable systems. Some data serialization languages include Schema, which defines the structure and types of data for consistent serialization; YAML, a human-readable standard used for configuration files and data exchange; JSON, a lightweight format widely used for web data interchange; XML, a flexible format for defining custom data structures in web services and configuration files; Protocol Buffers (ProtoBuf), an efficient and performance-oriented mechanism developed by Google for serializing structured data; Apache Avro, a binary serialization framework designed for big data environments within the Hadoop ecosystem; and Thrift, an interface definition language and binary communication protocols.

Diagram 1400 further illustrates how YAML file 1402 can include a mobile operator detail 1406, a mobile operator detail 1408, and a mobile operator detail 1410. The mobile operator details may correspond to details, fields, values, and/or any other suitable items of information that the mobile operator stores in a structured manner and that relate to the provisioning of telecommunication services to corresponding clients or subscribers. Illustrative examples of such details may include any one or more of the values, items of data, and/or fields described above in connection with FIGS. 3, 4, 7, 10, and/or 11, for example. Accordingly, each particular rule and/or each particular scenario that dynamically triggers a respective notification may furthermore be associated with the particular specification of the payload to be generated as part of the notification. By way of illustrative example, the value-added service provider may specify that the payload should include the mobile station international subscriber directory number for some rules or notifications (e.g., Android devices), but not for others (iOS devices). Similarly, the value-added service provider may specify that the payload should include the product identifier for some rules or notifications (e.g., account suspensions), but not for others (e.g., account activations). The value-added service provider may specify these dynamic preferences using one or more graphical user interfaces, as in diagram 1300, and/or through checking checkboxes and/or using any one or more of the other graphical user interface methodologies that are further described above. Accordingly, the value-added service provider may dynamically specify which particular details or items of data should be extracted from YAML file 1402 and be combined into the payload for a corresponding rule or notification.

The various instances of an indicator 1405 show that YAML file 1402 may further include additional instances of mobile operator rules. The mobile operator rules may specify the triggering conditions for sending a particular notification, consistent with the discussion above. These rules may reflect, or be based on, one or more instances of mobile operator preferences, such as a mobile operator preference 1416, a mobile operator preference 1418, and a mobile operator preference 1420. As discussed above in connection with diagram 1300, in some examples the application programming interface may provide a graphical user interface or other wizard that facilitates the value-added service provider indicating these corresponding preferences. The application programming interface and/or other wizard may generate YAML file 1404 based upon the input from the value-added service provider. Moreover, the application programming interface may incorporate the indications of these preferences into YAML file 1402, thereby generating corresponding rules that can be applied by a rules engine when issuing or triggering notifications to the various value-added service providers.

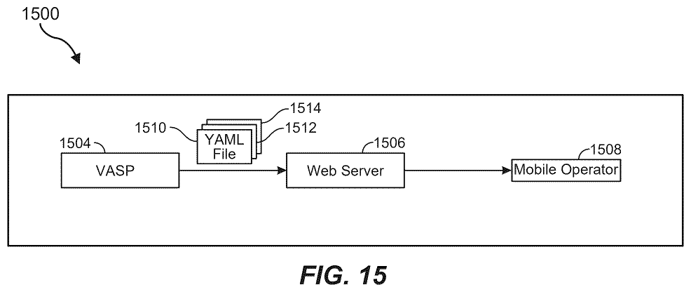

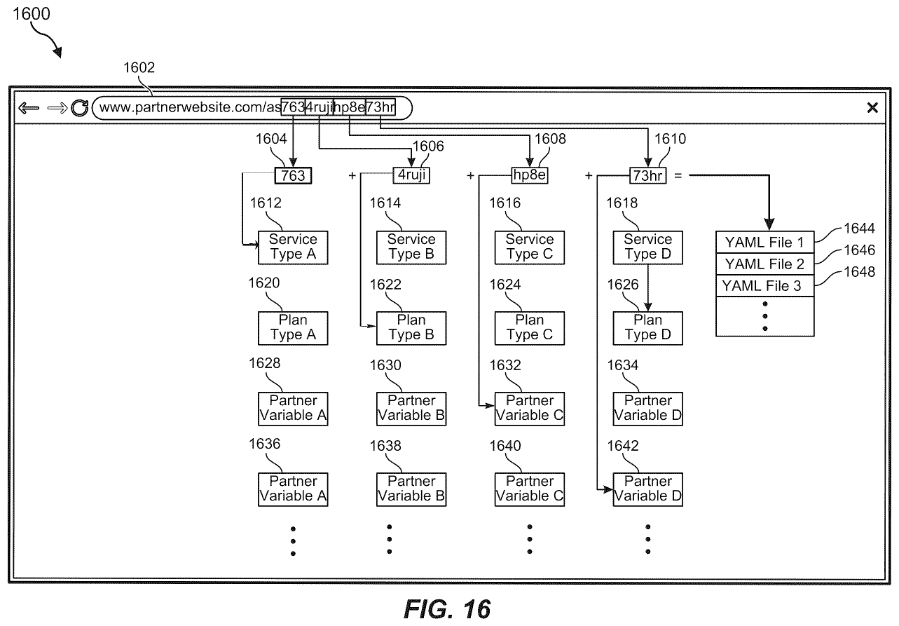

FIG. 15 shows a diagram 1500 indicating how different value-added service providers may upload respective data serialization language specification files to a corresponding web server for retrieval by a mobile operator. In particular, diagram 1500 shows that a value-added service provider 1504 can upload one or more YAML files, such as a YAML file 1510, a YAML file 1512, and a YAML file 1514, to a corresponding web server 1506, which may optionally be hosted by the respective value-added service providers. In the example of diagram 1500, a mobile operator 1508 may retrieve one or more, or all, of these files from web server 1506. Diagram 1500 helps to illustrate how value-added service providers retain the option of uploading different files for different respective services or products that the value-added service providers provide for clients of the mobile operator. Using different and respective files can simplify the overall process of indicating corresponding preferences for outbound communication from the mobile operator to the value-added service provider, as discussed in more detail below. Moreover, although the example of diagram 1500 focuses on a single value-added service provider uploading multiple and distinct files to the web server for each one of different respective products and/or services, in other examples various different value-added service providers may each maintain their own respective web servers and/or websites, which can host a respective plurality of such configuration files, as discussed further below in connection with the example of diagram 1600 of FIG. 16.

FIG. 16 shows a diagram 1600 indicating how a uniform resource locator may be dynamically generated or analyzed such that a single value-added service provider can store multiple distinct data serialization language specification files on a corresponding web server for retrieval by a particular mobile operator. Diagram 1600 shows an address bar 1602 within a corresponding graphical user interface, where the uniform resource locator inside of the address bar has been graphically divided into subsets, including a subset 1604, a subset 1606, a subset 1608, and a subset 1610, which can each provide a value of metadata used to specify a different YAML file for retrieving by the mobile operator. More specifically, diagram 1600 further indicates how subset 1604 may specify service type 1612 from among a plurality of service types that include a service type 1614, a service type 1616, and a service type 1618. The remaining subsets, including subset 1606, subset 1608, and subset 1610 similarly pick out, in a parallel manner, a plan type 1622 (from among a plan type 1620, a plan type 1624, and a plan type 1626), a generic value-added service provider variable value 1632 (from among a generic value-added service provider variable value 1628, a generic value-added service provider variable value 1630, and a generic value-added service provider variable value 1634), and a generic value-added service provider variable value 1642 (from among a generic value-added service provider variable value 1636, a generic value-added service provider variable value 1638, and a generic value-added service provider variable value 1640). The use of generic value-added service provider variables helps to illustrate how the example of diagram 1600 is merely illustrative and, in additional or alternative examples, the value-added service provider retains the option to separate or distinguish different configuration files from each other along any other suitable variable or metric that can be encoded within a uniform resource locator, consistent with the discussion above.

In view of the above, diagram 1600 further indicates that the uniform resource locator of the address bar indicates a target, corresponding to the aggregation of subset 1604, subset 1606, subset 1608, and subset 1610, of a YAML file 1644. In contrast, if one or more of the various characters within these subsets have been altered, then the overall uniform resource locator may pick out a different YAML file, such as a YAML file 1646 and/or a YAML file 1648, as shown.

More generally, uniform resource locator metadata encoding is a sophisticated method that value-added service providers can employ within the mobile operator application programming interface ecosystem to dynamically generate unique uniform resource locators for accessing YAML or other configuration files tailored to specific products or services. This technique involves embedding information or metadata directly into the uniform resource locator structure itself, thus enabling seamless retrieval of distinct YAML configurations by the mobile operator. The process can begin with the service provider identifying key parameters or identifiers associated with each product or service offered. These parameters could encompass various attributes such as product name, ID, version, or any other relevant distinguishing factors. Once these parameters are identified, they can be encoded into the uniform resource locator using a predetermined encoding scheme. This encoding scheme may involve techniques such as uniform resource locator-safe Base64 encoding or custom encoding algorithms specifically designed to accommodate the metadata requirements. Once the metadata is encoded into the uniform resource locator, the provider can dynamically generate a unique uniform resource locator for each YAML file based on the specific parameters of the associated product or service. This dynamic uniform resource locator generation process can ensure that each YAML file has its own distinct uniform resource locator, facilitating easy retrieval and differentiation by the mobile operator. Moreover, the encoded metadata within the uniform resource locator can serve as a roadmap, guiding the operator to the precise YAML configuration file corresponding to the requested product or service.

When the mobile operator seeks to access a YAML file for outbound communication preferences related to a particular product or service, it can simply request the corresponding dynamically generated uniform resource locator from the service provider. The provider's server interprets the uniform resource locator, decodes the metadata embedded within it, and retrieves the appropriate YAML file based on the decoded parameters. This seamless retrieval process can help ensure that the operator obtains the correct configuration data without the need for manual intervention or complex routing mechanisms. Furthermore, uniform resource locator metadata encoding offers several benefits beyond just efficient organization and retrieval of YAML files. It enhances system flexibility and scalability by allowing the provider to easily generate new uniform resource locators and YAML files for future products or updates. Additionally, since the metadata is encoded directly into the uniform resource locator, there is no need for separate storage mechanisms or databases to manage the associations between YAML files and their respective products or services.

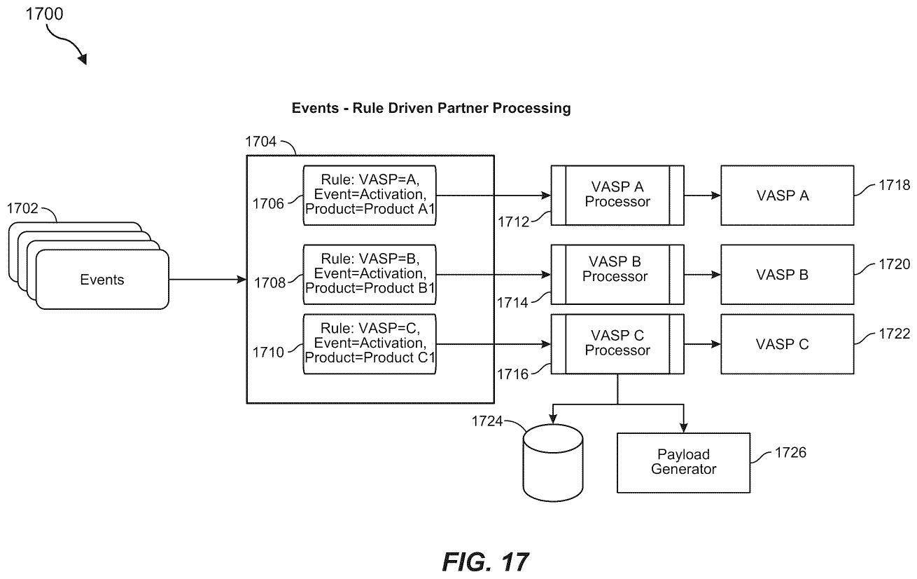

FIG. 17 shows a diagram 1700 indicating a workflow for rules-driven processing of events for outbound notifications to corresponding value-added service providers. In particular, diagram 1700 shows that events 1702 can be input to a rules set 1704, which includes a rule 1706, a rule 1708, and a rule 1710, as shown. In response, a respective value-added service provider processor, such as a value-added service provider processor 1712, a value-added service provider processor 1714, and/or a value-added service provider processor 1716 may apply the respective rule to generate a corresponding notification to a respective value-added service provider, such as a value-added service provider 1718, a value-added service provider 1720, and/or a value-added service provider 1722. As part of this process, each respective value-added service provider processor may reference a database 1724 and/or may retrieve the corresponding payload that was generated by payload generator 1726, consistent with the discussion above.

Rules set 1704 can play a role in orchestrating the distribution of notifications to various partners based on predefined criteria. Each rule within this set can delineate specific conditions under which a partner should receive notifications, ensuring tailored communication in response to diverse subscription activation events across different products and services. Beyond subscription activations, various other types of rules can be applied within the rules set to govern the dissemination of notifications to partners. These rules can encompass a wide array of scenarios and criteria, including but not limited to, subscription cancellations, account upgrades, payment failures, service interruptions, promotional offers, and regulatory compliance requirements. Additionally, the rules can incorporate a multitude of variables to ensure granularity and precision in determining when and how notifications are dispatched. These variables may include product or service identifiers, value-added service provider IDs, geographical locations, subscriber demographics, subscription plans, billing cycles, event timestamps, notification formats, delivery channels, and priority levels, among others.

Furthermore, the rules set may encompass not only rules specifying which partners receive notifications but also rules dictating the content and format of the notifications themselves. For example, certain rules might mandate that one value-added service provider receives notifications in real-time via SMS for high-priority subscription activations, while another and distinct value-added service provider receives daily email digests summarizing all subscription-related events. This granular control over notification delivery ensures that value-added service providers receive timely, relevant information tailored to their preferences and operational requirements.

FIG. 18 shows a diagram 1800 indicating a workflow for generating a mapper file based on two respective data serialization language specification files. In general, diagram 1800 should be interpreted in the context of the above discussions, including especially the discussions of FIGS. 12-17. Consistent with those discussions, diagram 1800 shows how automatic mapper file generation 1804 may automatically generate a mapper file 1810 based on a value-added service provider YAML file that specifies outbound communication preferences that the value-added service provider has for receiving outbound communications from the mobile operator to the value-added service provider, as further discussed above. Additionally, automatic mapper file generation 1804 may have access to, or may input, a source YAML file 1802, which can correspond to a file or database storing relevant mobile operation service details as maintained by the mobile operator. More generally, source YAML file 1802 may correspond to all, or a portion of, the centralized database that the mobile operator maintains to record details in connection with mobile operation services and on which the mobile operator relies for service operations. The centralized database may include any one or more of the items of information that are listed above, including the discussion of diagram 700 of FIG. 7, for example.

Mapper file 1810 may generally map the preferences indicated by value-added service provider YAML file 1806 onto respective targets, fields, and/or data structures within source YAML file 1802, thereby indicating which particular values, items of information, and/or other details from source YAML file 1802 should be extracted and packaged together as part of a payload for a specific and customized notification, consistent with the discussion above. In a scenario where automatic mapper file generation 1804 encounters a challenge, obstacle, or error when attempting to appropriately map these two sets of data together, the value-added service provider and/or an administrator 1808 may modify and/or accept all or portions of mapper file 1810 accordingly, as shown. Upon generation, mapper file 1810 may be stored within a cloud storage bucket at a step 1812. At step 1812, additional metadata may also be optionally stored together with the mapper file. In response to one or more of the events outlined and described above, such as events 1814 depicted in diagram 1800, the application programming interface may generate an output payload for the value-added service provider at a step 1816. Subsequently, at a step 1818, the value-added service provider payload may be transmitted to the value-added service provider consistent with the above discussion and consistent with method 100 and/or method 1200, for example.

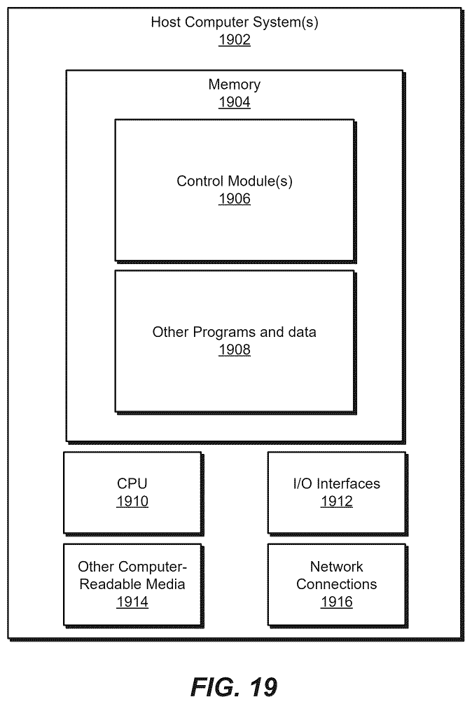

FIG. 19 shows a system diagram that describes an example implementation of a computing system(s) for implementing embodiments described herein. The functionality described herein can be implemented either on dedicated hardware, as a software instance running on dedicated hardware, or as a virtualized function instantiated on an appropriate platform, e.g., a cloud infrastructure. In some embodiments, such functionality may be completely software-based and designed as cloud-native, meaning that they are agnostic to the underlying cloud infrastructure, allowing higher deployment agility and flexibility. However, FIG. 19 illustrates an example of underlying hardware on which such software and functionality may be hosted and/or implemented.

In particular, shown is example host computer system(s) 1902. For example, such computer system(s) 1902 may execute a scripting application, or other software application, as further discussed above, and/or to perform one or more of the other methods described herein. In some embodiments, one or more special-purpose computing systems may be used to implement the functionality described herein. Accordingly, various embodiments described herein may be implemented in software, hardware, firmware, or in some combination thereof. Host computer system(s) 1902 may include memory 1904, one or more central processing units (CPUs) 1910, I/O interfaces 1912, other computer-readable media 1914, and network connections 1916.

Memory 1904 may include one or more various types of non-volatile and/or volatile storage technologies. Examples of memory 1904 may include, but are not limited to, flash memory, hard disk drives, optical drives, solid-state drives, various types of random access memory (RAM), various types of read-only memory (ROM), neural networks, other computer-readable storage media (also referred to as processor-readable storage media), or the like, or any combination thereof. Memory 1904 may be utilized to store information, including computer-readable instructions that are utilized by CPU 1910 to perform actions, including those of embodiments described herein.

Memory 1904 may have stored thereon control module(s) 1906. The control module(s) 1906 may be configured to implement and/or perform some or all of the functions of the systems or components described herein. Memory 1904 may also store other programs and data 1908, which may include rules, databases, application programming interfaces, software containers, nodes, pods, clusters, node groups, control planes, software defined data centers (SDDCs), microservices, virtualized environments, software platforms, cloud computing service software, network management software, network orchestrator software, network functions (NF), artificial intelligence (AI) or machine learning (ML) programs or models to perform the functionality described herein, user interfaces, operating systems, other network management functions, other NFs, etc.

Network connections 1916 are configured to communicate with other computing devices to facilitate the functionality described herein. In various embodiments, the network connections 1916 include transmitters and receivers (not illustrated), cellular telecommunication network equipment and interfaces, and/or other computer network equipment and interfaces to send and receive data as described herein, such as to send and receive instructions, commands and data to implement the processes described herein. I/O interfaces 1912 may include a video interface, other data input or output interfaces, or the like. Other computer-readable media 1914 may include other types of stationary or removable computer-readable media, such as removable flash drives, external hard drives, or the like.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method comprising:
identifying, by a mobile operator or an independent mobile telecommunication enhancement operation that provides a mobile telecommunication enhancement for clients of the mobile operator, an application programming interface that integrates the mobile operator with the independent mobile telecommunication enhancement operation such that the application programming interface translates between data structures for fields that record mobile service operation details in a format that the mobile operator uses internally and second data structures for corresponding fields that record corresponding mobile service operation details in a distinct format that the independent mobile telecommunication enhancement operation uses internally; and
providing or accessing, by the mobile operator or the independent mobile telecommunication enhancement operation that provides the mobile telecommunication enhancement for clients of the mobile operator, the application programming interface that integrates the mobile operator with the independent mobile telecommunication enhancement operation such that the application programming interface translates between the first data structures for fields that record mobile service operation details in the format that the mobile operator uses internally and the second data structures for corresponding fields that record corresponding mobile service operation details in the distinct format that the independent mobile telecommunication enhancement operation uses internally.

2. The method of claim 1, wherein the mobile telecommunication enhancement comprises a cable-television option, a secure Wi-Fi Internet connection option, an international calling option, a cloud storage option, a Voice Over Internet Protocol option, a streaming content service membership option, or a device insurance option.

3. The method of claim 1, wherein:
the application programming interface enables the independent mobile telecommunication enhancement operation to proactively edit a field of an authoritative profile that is maintained by the mobile operator and that is specific to the independent mobile telecommunication enhancement operation or is specific to a client to which the independent mobile telecommunication enhancement operation is providing the mobile telecommunication enhancement; and
the field of the authoritative profile comprises a specification of whether the mobile telecommunication enhancement has been applied as a bolton to the authoritative profile that is specific to the client to which the independent mobile telecommunication enhancement operation is providing the mobile telecommunication enhancement.

4. The method of claim 3, further comprising the independent mobile telecommunication enhancement operation editing the field of the authoritative profile comprising the specification of whether the mobile telecommunication enhancement has been applied as the bolton to the authoritative profile that is specific to the client to which the independent mobile telecommunication enhancement operation is providing the mobile telecommunication enhancement such that a status of the bolton is switched.

5. The method of claim 1, wherein the application programming interface provides the independent mobile telecommunication enhancement operation with limited read/write access to an internal database that the mobile operator relies on as part of the mobile operator providing telecommunication services to the clients.

6. The method of claim 1, wherein the application programming interface is configured such that the application programming interface authenticates the independent mobile telecommunication enhancement operation prior to enabling the independent mobile telecommunication enhancement operation to proactively edit a field of an authoritative profile that is maintained by the mobile operator and that is specific to the independent mobile telecommunication enhancement operation or is specific to a client to which the independent mobile telecommunication enhancement operation is providing the mobile telecommunication enhancement.

7. The method of claim 1, wherein the application programming interface provides a graphical user interface to streamline a process of onboarding the independent mobile telecommunication enhancement operation with the mobile operator such that configuring how the mobile operator and the independent mobile telecommunication enhancement operation are integrated is performed by the independent mobile telecommunication enhancement operation.

8. The method of claim 1, wherein the mobile operator charges for the mobile telecommunication enhancement and also for providing telecommunication service to a respective client in a same statement.

9. The method of claim 1, wherein the application programming interface enables the independent mobile telecommunication enhancement operation to dynamically specify preferences that the independent mobile telecommunication enhancement operation has for subscribing to outbound communications from the mobile operator to the independent mobile telecommunication enhancement operation.

10. The method of claim 9, wherein the application programming interface enables the independent mobile telecommunication enhancement operation to dynamically specify preferences that the independent mobile telecommunication enhancement operation has for subscribing to outbound communication from the mobile operator to the independent mobile telecommunication enhancement operation such that the preferences can vary according to different values of different respective variables including an event variable and a platform variable.

11. The method of claim 10, wherein the event variable specifies between changes in a status of the client.

12. The method of claim 11, wherein the event variable specifies between changes in the status of the client at least in part by specifying a switch from active to suspended status, a switch revoking suspension, a switch activating service, a switch deactivating service, a switch transferring to a distinct mobile network, or a switch from one device using a first mobile operating system platform and a second device having a second and distinct mobile operating system platform.

13. The method of claim 1, wherein the corresponding data structures for fields that record mobile service operation details in the format that the mobile operator uses internally and the second data structures for corresponding fields that record corresponding mobile service operation details in the distinct format that the independent mobile telecommunication enhancement operation uses to record internally at least two of the mobile station international subscriber directory number, the international mobile equipment identity, the subscriber identity module, the integrated circuit card identifier, a subscription status, an account balance, a roaming status, a device make, a device model, or an authentication credential.

14. The method of claim 1, wherein the application programming interface enables the mobile operator to generate a data serialization language specification file for the independent mobile telecommunication enhancement operation that indicates outbound communication preferences of the independent mobile telecommunication enhancement operation based on input from the independent mobile telecommunication enhancement operation regarding outbound communication from the mobile operator to the independent mobile telecommunication enhancement operation.

15. The method of claim 14, wherein the application programming interface generates a mapper file based on the data serialization language specification file for the independent mobile telecommunication enhancement operation and a distinct source data serialization language specification file for the mobile operator.

16. The method of claim 14, wherein the data serialization language specification file comprises a YAML file.

17. A system comprising:
at least one physical computing processor; and
a non-transitory computer-readable medium that has instructions stored thereon that, when executed by the at least one physical computing processor, cause a computing device to perform operations comprising:
identifying, by a mobile operator or an independent mobile telecommunication enhancement operation that provides a mobile telecommunication enhancement for clients of the mobile operator, an application programming interface that integrates the mobile operator with the independent mobile telecommunication enhancement operation such that the application programming interface translates between data structures for fields that record mobile service operation details in a format that the mobile operator uses internally and second data structures for corresponding fields that record corresponding mobile service operation details in a distinct format that the independent mobile telecommunication enhancement operation uses internally; and
providing or accessing, by the mobile operator or the independent mobile telecommunication enhancement operation that provides the mobile telecommunication enhancement for clients of the mobile operator, the application programming interface that integrates the mobile operator with the independent mobile telecommunication enhancement operation such that the application programming interface translates between the first data structures for fields that record mobile service operation details in the format that the mobile operator uses internally and the second data structures for corresponding fields that record corresponding mobile service operation details in the distinct format that the independent mobile telecommunication enhancement operation uses internally.

18. The system of claim 17, wherein the mobile telecommunication enhancement comprises a cable-television option, a secure Wi-Fi Internet connection option, an international calling option, a cloud storage option, a Voice Over Internet Protocol option, a streaming content service membership option, or a device insurance option.

19. A non-transitory computer-readable medium that has instructions stored thereon that, when executed by at least one physical computing processor, cause a computing device to perform operations comprising:
identifying, by a mobile operator or an independent mobile telecommunication enhancement operation that provides a mobile telecommunication enhancement for clients of the mobile operator, an application programming interface that integrates the mobile operator with the independent mobile telecommunication enhancement operation such that the application programming interface translates between data structures for fields that record mobile service operation details in a format that the mobile operator uses internally and second data structures for corresponding fields that record corresponding mobile service operation details in a distinct format that the independent mobile telecommunication enhancement operation uses internally; and
providing or accessing, by the mobile operator or the independent mobile telecommunication enhancement operation that provides the mobile telecommunication enhancement for clients of the mobile operator, the application programming interface that integrates the mobile operator with the independent mobile telecommunication enhancement operation such that the application programming interface translates between the first data structures for fields that record mobile service operation details in the format that the mobile operator uses internally and the second data structures for corresponding fields that record corresponding mobile service operation details in the distinct format that the independent mobile telecommunication enhancement operation uses internally.

20. The non-transitory computer-readable medium of claim 19, wherein the mobile telecommunication enhancement comprises a cable-television option, a secure Wi-Fi Internet connection option, an international calling option, a cloud storage option, a Voice Over Internet Protocol option, a streaming content service membership option, or a device insurance option.
